(19) United States
(12) Patent Application Publication
(10) Pub. No.: US 2016/0236415 A1
(43) Pub. Date: Aug. 18, 2016

(54) DYNAMIC CELLULAR MICROSTRUCTURE CONSTRUCTION

(71) Applicant: nTopology Inc., New York City, NY (US)

(72) Inventor: BRADLEY A. ROTHENBERG, New York City, NY (US)

(21) Appl. No.: 14/621,380

(22) Filed: Feb. 13, 2015

(51) Int. Cl. B29C 67/00; G05B 19/4099

(52) U.S. Cl. CPC B29C 67/0088; G05B 19/4099; G05B 2219/35134; G05B 2219/49007; B33Y 50/02

(57) ABSTRACT

Dynamic cellular microstructure designs customize production in an additive manufacturing construction. A seamless mesh generated from an input shape, based on available scans and/or surface designs, is supplemented with curvature data derived from the input shape. Redesign of a base shape and/or group of base shapes within a seamless mesh enable customization in localized areas of the seamless mesh. The seamless mesh may also be retopologized according to localized feature attractor points. Base shape redesign includes cellular replication, subdivision, growth, and/or modification to adjust variable material properties. Modification changes relative opacity, stretch, drape, compressive strength, plasticity, yield strength, resilience, and Poisson's ratio specific to geometry of a base shape. Each base shape can also exhibit modifiable isotropic or anisotropic properties.

### FIELD

The present disclosure relates to additive manufacturing techniques for generating a 3D printable object. More particularly, to systems and methods for creating a seamless mesh exhibiting localized customization to fill a multidimensional input surface.

### BACKGROUND

Traditional manufacturing techniques prefer uniformity in the manufactured goods being produced. Unfortunately, within a product design, specific portions of the design may require variability that would normally preclude use of single-piece manufacturing techniques. Accordingly, a product may be composed of several pieces or components joined together to accommodate these variations. For example, in clothing construction, two or more layers of fabric, plastic, leather, or other materials may be joined together along a seam, which stitches the different components together. Great care is taken during product design with respect to placement (e.g., inseam, center back seam, side seam, etc.) and type (e.g., plain, lapped, abutted, etc.) of the seams used to create a garment that fits properly. The result is a garment with several different component pieces joined together by several seams into a single article of clothing.

Additive manufacturing allow traditionally separate portions of a product to be made without seams or welds. While additive manufacturing techniques can eliminate some of the seams between similar components in a product, some required variability cannot be eliminated by existing techniques that assume fabric uniformity. Moreover, when producing a product using an additive manufacturing process, the product design itself is often changed by the very materials used to manufacture the design. Thus, traditionally, component materials are selected by the manufacturer afterwards to match a desired design. Alternatively, if use of a particular material is desired, the design must incorporate that material from the beginning of the design process. Accordingly, any existing seamless product produced using currently available additive manufacturing techniques is limited to a single material selected for exhibiting properties consistent with the target design.

### BRIEF DESCRIPTION OF THE DRAWINGS

The aspects of the present disclosure are best understood from the detailed description when read in relation to the accompanying drawings. The drawings illustrate a variety of different aspects, features, and embodiments of the disclosure, as such it is understood that the illustrated embodiments are merely representative and not exhaustive in scope. The disclosure will now be described with reference to the accompanying drawings, wherein like numbers refer to like elements.

FIG. 1 illustrates a suitable dynamic cellular microstructure design and construction environment wherein designs with attractor points may be applied to available scans with curvature data and retopologized for application to an additive manufacturing construction in accordance with at least one embodiment.

FIG. 2 illustrates several components of a cellular microstructure design and construction server in accordance with one embodiment.

FIG. 3 illustrates several components of a design server in accordance with one embodiment.

FIG. 4 illustrates several components of a scanner server in accordance with one embodiment.

FIG. 5 illustrates several components of an additive manufacturer for 3D printing shown in accordance with one embodiment.

FIG. 6 illustrates a flow diagram of a cellular microstructure design/seamless mesh production routine for the seamless mesh server shown in FIG. 2 in accordance with one embodiment.

FIG. 7A illustrate subdivision of a triangular base shape in accordance with one embodiment.

FIG. 7B illustrate subdivision of a textile cell with a triangular base shape in accordance with one embodiment.

FIG. 8A illustrate subdivision of a square base shape in accordance with one embodiment.

FIG. 8B illustrate subdivision of a textile cell with a square base shape in accordance with one embodiment.

FIG. 9A illustrate subdivision of a pentagon base shape in accordance with one embodiment.

FIG. 9B illustrate subdivision of a textile cell with a pentagon base shape in accordance with one embodiment.

FIG. 10A illustrate subdivision of a hexagon base shape in accordance with one embodiment.

FIG. 10B illustrate subdivision of a textile cell with a hexagon base shape in accordance with one embodiment. octagon

FIG. 11A illustrate subdivision of a octagon base shape in accordance with one embodiment.

FIG. 11B illustrate subdivision of a textile cell with a octagon base shape in accordance with one embodiment.

FIG. 12 illustrates an aggregation of textile cells demonstrating an edge interconnection interlocking neighboring textile cells in accordance with one embodiment.

FIG. 13 illustrates an aggregation of textile cells with an overlapping edge interlocking neighboring textile cells in accordance with one embodiment.

FIG. 14A illustrates an aggregate surface with several triangular template cells in accordance with one embodiment.

FIG. 14B illustrates a textile cell mapped to a template cell of a triangular base shape within an aggregate surface in accordance with one embodiment.

FIG. 15 illustrates mapping a textile cell onto a template cell of a triangular base shape in accordance with one embodiment.

FIG. 16A illustrates variations of a triangular base shape including a textile cell and an inverted textile cell in accordance with one embodiment.

FIG. 16B illustrates a textile cell joined to an inverted textile cell in accordance with one embodiment.

FIG. 16C illustrates a plan view of a hexagon base shape formed from an aggregation of triangular base shapes in accordance with one embodiment.

FIG. 16D illustrates a perspective view of the hexagon base shape shown in FIG. 16C in accordance with one embodiment.

FIG. 16E illustrates a triangular composite mesh using triangle base shapes and inverted triangle base shapes in accordance with one embodiment.

FIG. 16F illustrates a plan view of a hexagon composite mesh formed from the hexagon base shape shown in FIG. 16C in accordance with one embodiment.

FIG. 16G illustrates a perspective view of the hexagon composite seamless mesh shown in FIG. 16F in accordance with one embodiment.

FIG. 17A illustrates a plan view of a triangular input shape including multiple attractor points (B. C. and D) in accordance with one embodiment.

FIGS. 17B, 17C, and 17D each illustrate different top views of a seamless mesh thickening different textile cells near each attractor point (B, C, and D respectively) in accordance with various embodiments.

FIG. 18A illustrates a perspective view of the seamless mesh shown in FIG. 17C in accordance with one embodiment.

FIG. 18B illustrates a side view of the seamless mesh shown in FIG. 18A in accordance with one embodiment.

FIG. 19A illustrates a plan view of an octahedral base shape in accordance with one embodiment.

FIG. 19B illustrates a perspective view of the octahedral base shape in FIG. 19A in accordance with one embodiment.

FIG. 19C illustrates a plan view of a volumetric replication of the octahedral base shape shown previously in FIG. 19A and eight tetrahedral base shapes shown previously in FIG. 19E in accordance with one embodiment.

FIG. 19D illustrates a perspective view of a volumetric replication of the octahedral base shape shown previously in FIG. 19A and eight tetrahedral base shapes shown previously in FIG. 19E in accordance with one embodiment.

FIG. 19E illustrates a plan view of a tetrahedral base shape in accordance with one embodiment.

FIG. 19F illustrates a perspective view of the tetrahedral base shape in FIG. 19E in accordance with one embodiment.

FIG. 19G illustrates a plan view of a volumetric replication of the tetrahedral base shape shown in FIG. 19E and four octahedral base shapes shown in FIG. 19A in accordance with one embodiment.

FIG. 19H illustrates a perspective view of a volumetric replication of the tetrahedral base shape shown in FIG. 19E and four octahedral base shapes shown in FIG. 19A in accordance with one embodiment.

FIG. 19I illustrates a perspective view of a volumetric space of an input shape that includes three overlapping spheres in accordance with one embodiment.

FIG. 19J illustrates a perspective view of a seamless mesh of the input shape in FIG. 19I in accordance with one embodiment.

FIG. 20 illustrates a perspective view of a mesh generated from a 3D scan input in accordance with one embodiment.

FIG. 21 illustrates a perspective view of an input shape selected from a portion of the 3D scan in FIG. 20 in accordance with one embodiment.

FIG. 22 illustrates a perspective view of an irregular mesh of the input shape in accordance with one embodiment

FIG. 23 illustrates a perspective view of the original mesh tessellation replaced with a triangular base shape in accordance with one embodiment.

FIG. 24 illustrates a perspective view of a regular mesh of the input shape in accordance with one embodiment.

FIG. 25 illustrates a perspective view of the regular mesh with a triangular textile-cell in accordance with one embodiment.

FIG. 26 illustrates an elevation view of an input mesh in accordance with one embodiment.

FIG. 27 illustrates a plan view the mesh shown in FIG. 26 in accordance with one embodiment.

FIG. 28 illustrates a curvature map of the mesh shown in FIG. 26 in accordance with one embodiment.

FIG. 29A and FIG. 29B illustrate top views of new subdivided input meshes in accordance with one embodiment.

FIG. 30A and FIG. 30B illustrates top views of textile cells being applied to the new subdivided input meshes shown in FIG. 29A and FIG. 29B in accordance with one embodiment.

FIG. 31 illustrates a top view the mesh using multiple base shapes in accordance with one embodiment.

FIG. 32A and FIG. 32B illustrate top views of the input mesh with attractor points in accordance with one embodiment.

FIG. 33A and FIG. 33B illustrate top views of textile cells applied to the input mesh with attractor points in accordance with one embodiment.

FIG. 34 illustrates a top view of a seamless mesh with curvature variation in accordance with one embodiment.

FIG. 35 illustrates a top view the seamless mesh with attractor point and curvature variation in accordance with one embodiment.

### DETAILED DESCRIPTION

In accordance with various embodiments of the invention, dynamic cellular microstructure construction systems and methods are described that overcome the hereinafore-mentioned disadvantages of the heretofore-known additive manufacturing methods and systems of this general type and that provide for customization in localized areas of a seamless mesh. More specifically, the described embodiments provide a seamless mesh generated from an input shape, based on available scans and/or surface designs, and supplemented with curvature data derived from the input shape. Redesign of a base shape and/or group of base shapes within a seamless mesh enable customization in localized areas of the seamless mesh. The seamless mesh may also be retopologized according to localized feature attractor points. Base shape redesign includes cellular replication, subdivision, growth, and/or modification to adjust variable material properties. Modification changes relative opacity, stretch, drape, compressive strength, plasticity, yield strength, resilience, and Poisson's ratio specific to geometry of a base shape. Each base shape can also exhibit modifiable isotropic or anisotropic properties.

In some embodiments, a method of manufacturing a seamless mesh may include obtaining at least one 3-D scan of a 3-D surface and/or a surface design to be at least partially covered by the seamless mesh, demarcating a portion of the obtained 3-D scan and/or surface design as an input shape for the seamless mesh, identifying at least one base shape for use in creating the seamless mesh on the input shape, replicating the at least one base shape to cover the input shape with replicated base shapes that form the seamless mesh, and/or modifying the at least one base shape in localized areas of the seamless mesh based on relative proximity curvature of the input shape. In some embodiments, the modifying the base shape may include changing at least one of opacity, thickness, stretch, drape, and size of the base shape. In one embodiment, the base shape represents a combination of material (textile) and rules (template). Modifications to the base shape can produce variable material properties. For example, parts of the base shape can thicken or thin, new connections can be added or removed within the base shape, and the method a base shape connects to its neighbor can change from interlocking to interconnecting. These changes can also alter a material's opacity, stretch, drape, as well as the final materials yield strength, Poisson's ratio, and/or compressive strength. The chosen base shape can also have isotropic or anisotropic properties, where isotropic properties of a base shape are the same in all orientations and anisotropic properties exhibit different properties depending on the orientation of the base shape.

In some embodiments, the base shape is a space filling polyhedral. For example, depending on the desired application, a base shape may be 2D and/or 3D (polygon/polyhedron). The template shape of a base shape can be a 2-D space filling polygons, such that they create a tessellation over the input shape, or a 3-D space filling polyhedron filling the input space. In one embodiment, the 3D Textile cells are mapped to the 2-D shapes. In another embodiment, 3D textile cells can also be mapped to 3D space filling polyhedra, this allows for a volumetric lattice, which can fill a volume defined by the boundaries of an input surface.

In some embodiments, the replicating the base shape may include identifying at least one vertex of an original base shape, generating at least one additional base shape and rotating placement of the generated at least one additional base shape about the at least one vertex of the original base shape, upon placement of the at least one additional base shape about the original base shape continuing replication of the base shape using the at least one additional base shape as the new original base shape until the at least one additional base shape reaches an edge of the input surface.

In some embodiments, the at least one base shape is interlocked with at least one additional replicated base shape. In some embodiments, the at least one base shape and at least one additional replicated base shape are joined along at least one edge of the base shape. In some embodiments, the at least one base shape partially overlaps with at least one neighboring base shape. In some embodiments, the at least one 3-D scan of a 3-D surface is a 3-D model. In some embodiments, the surface design is independent of the at least one 3-D scan of the 3-D surface and may further include modifying the surface design to cover the 3-D surface based on the 3-D scan. In some embodiments, the surface design may include identification of relative design parameters desirable for the seamless mesh. In some embodiments, the design parameters may include opacity, thickness, stretch, drape, and size. In some embodiments, the surface design is an article of clothing. In some embodiments, such a method may further include printing the seamless mesh using additive manufacturing techniques. In some embodiments, the identifying the at least one base shape for the mesh may include identifying different base shapes based on the surface design. For example, when mapping the base shape to the input shape, template cells of a base shape can subdivide in areas of high curvature, to allow the material to better approximate the shape. Similarly, an alternative template cell (e.g., switching from a square to triangle) may be substituted for the base shape to allow the material to better approximate the shape.

In one embodiment, the described technology may be used to produce textiles that can be customized to the needs and desires of the purchaser. In particular, the described technology can produce textiles using 3D printing that allow for the generation of textiles in multiple dimensions. One can adjust the geometry of the weave of the specific textile and manipulate that geometry to have different formative qualities throughout a garment. With data from a multidimensional scan, one can customize a garment to the specific shape of the wearer in a variety of positions. More specifically, the invention allows for textiles to be generated with multiple properties throughout. By “growing,” a weave using the fractal mathematics, the weave is able to variably thicken throughout a textile as well as vary in density and size. This allows for a textile to take on multiple formative characteristics throughout a garment. Also, the described technology allows for the growth of a custom textile around a person, based on the input of 3D scanned data about that person. For example, a generated weave can be based off of the triangle and quad data from a .stl mesh file from a 3D scan. The resulting weave can then stretch, warp, and subdivide to allow for the design to accommodate more or less flexibility depending on the garment design parameters. In one embodiment, these weaves are combined to create a multi-dimensional interlocking matrix that forms a seamless mesh.

In the following detailed description, reference is made to the accompanying drawings which form a part hereof wherein like numerals designate like parts throughout, and in which are shown, by way of illustration, specific embodiments in which the disclosure may be practiced. Various aspects of the illustrative embodiments will be described using terms commonly employed by those skilled in the art to convey the substance of their work to others skilled in the art. However, the embodiments described herein may be practiced with only some of the described aspects. For purposes of explanation, specific numbers, materials, and configurations may be set forth to provide a thorough understanding of the illustrative embodiments. However, the embodiments described herein may be practiced without the specific details. In other instances, well-known features are omitted or simplified in order not to obscure the illustrative embodiments. Further, various operations and/or communications may be described as multiple discrete operations and/or communications, in turn, in a manner that may be helpful in understanding the embodiments described herein; however, the order of description should not be construed as to imply that these operations and/or communications are necessarily order dependent. In particular, these operations and/or communications need not be performed in the order of presentation.

The detailed description that follows is represented largely in terms of processes and symbolic representations of operations by conventional computing components, including a processor, memory storage devices for the processor, connected display devices and input devices. Furthermore, these processes and operations may utilize conventional computing components in a distributed computing environment; including remote file servers, servers, publishing resources, and/or memory storage devices. Each of these conventional distributed computing components is accessible by the processor via a network. In a distributed computing environment, clients, servers, and client/servers may be, for example, smartphones, mainframes, minicomputers, workstations, or personal computers. Most services in a distributed computing environment can be grouped into distributed file system, distributed computing resources, and messaging. A distributed file system provides a client with transparent access to part of the mass storage of a remote network device, such as a network-attached storage (NAS) or file-level computer data storage server. Distributed computing resources provide a client with access to computational or processing power of remote network devices, such as a cloud server. Messaging allow a client to manage the exchange of data and information between other device connected to the network. It is to be understood that other embodiments may be utilized and structural or logical changes may be made without departing from the scope of the present disclosure. Therefore, the following detailed description is not to be taken in a limiting sense, and the scope of a portion of the present disclosure is defined by the claims and appended drawings and their equivalents.

Throughout the specification and drawings, the following terms take at least the meanings explicitly associated herein, unless the context clearly dictates otherwise. The meanings identified below are not intended to limit the terms, but merely provide illustrative examples for use of the terms. The meaning of “a,” “an,” and “the” may include reference to both the singular and the plural. Reference in the specification to “one embodiment” or “an embodiment” means that a particular feature, structure, or characteristic described in connection with the embodiment is included in at least one embodiment of the disclosure, but are not necessarily included on all embodiments of the disclosure. The meaning of “in” may include “in” and “on.” The phrases “in one embodiment” or “in an embodiment” or “in various embodiments” or “in some embodiments” and the like are used repeatedly. Such phrases in various places in the specification do not necessarily all refer to the same embodiment, but it may unless the context dictates otherwise. The terms “comprising”, “having”, and “including” should be considered synonymous, unless context dictates otherwise. The phrase “A/B” means “A and/or B” or “A or B” depending on context. The phrase “A and/or B” means “(A), (B), or (A and B)”. The phrase “at least one of A, B, and C” means “(A), (B), (C), (A and B), (A and C), (B and C) or (A, B and C)”. The phrase “(A) B” means “(A B) or (B)”, that is “A” is optional. The use of any of these phrases does not imply or indicate that the particular feature, structure, or characteristic being described is a necessary component for every embodiment for which such a description is included.

The terms “3D scan” and “3D surface” may or may not be used interchangeably depending on context and typically refer to a method to capture a three dimensional representation of an object. More specifically, the term “3D scan”, without additional context, refers to a method to capture three dimensional points in the real world through a device, such as a camera/scanner that can understand height, width and depth of an object being scanned and may also identify other parameters of the scanned object including color. A reconstruction of the space that is scanned is possible by generating a mesh from these points. Comparatively, the term “3D surface” may refer to a two-dimensional topological manifold in 3-D space. Each point on the surface can be represented by a two-dimensional coordinate. Surfaces can be open, and have a boundary (ex. A plane), or closed (ex. A sphere). The term “input shape” refers to a 3D shape with any topology that is input either from an existing 3d model or is created from 3D scan data. Similarly, the term “base shape” refers to the combinational pair of a template cell and a textile cell, where the template cell has rules for growth and the textile cell gets updated parametrically based on the paired template cell.

The term “cover” typically refers to the process of multiplication, subdivision, substitution, and/or removal of a plurality of interconnected/interlocked base shapes onto a seamless mesh to distribute the mesh over the entire input shape. The terms “joined”, “interconnected”, and “interlocked” may or may not be used interchangeably depending on context and typically refer to methods of connecting individual cells and/or base shapes with each other. More specifically, the term “interlocked” refers to when two textile unit cells are knotted together, but not touching. The two textile unit cells cannot be pulled apart from one another, but the cells are free to move independently of each other along at least one axis. Interlocking may include interlocking portions, interconnected portions, and/or some combination of these. The term “interconnected” refers to when two textile unit cells are joined together and at that joint, movement is restricted in all axes. However, bending is possible. For example, spring-like connections can be interconnected. The term “joined” when used with reference to a project may refer to multiple designs that are brought together into a single project and are modified based on parameters of that project. The term “joined” when used with reference to an edge may refer to a situation when interconnecting/interlocking happens at an edge then neighboring cells are joined at the edge, alternatively if interlocking happens within a cell then each cell extends into neighboring cell to interlock.

The term “attractor point” refers to a point placed anywhere on the input shape. A value can be taken based on the distance from any point on the input shape to the attractor point's location. These values can be input into the scalar field that is created for the input shape. The term “curvature” typically refers to the measure of a rate of change in direction of a surface, which can often be measured by taking the reciprocal of the radius of the best fitting circle to the curve or surface at a point. Both curvature and attractor points may be used to identify localized areas of the seamless mesh subject to redesign. Base shape redesign may include cellular replication, subdivision, growth, and/or modification to adjust variable material properties. Modification changes relative opacity, stretch, drape, compressive strength, plasticity, yield strength, resilience, and Poisson's ratio specific to geometry of a base shape. For example, changing thickness and size of a base shape may have an effect on the overall design. More specifically, adding thickness usually increases strength, so a design that needs to be stronger in a particular location might thicken the base shape within that local area. Each base shape can also exhibit modifiable isotropic or anisotropic properties. In a unique orthotropic case, three perpendicular axis of a seamless mesh may exhibit three different behaviors/properties.

The terms “matrix”, “lattice”, “shell”, and “mesh” may or may not be used interchangeably depending on context and typically refer to either a surface or structure readily recognized as a Cartesian way of representing object geometry using vertices, edges, and faces. A vertex has a specific Cartesian coordinate in relative space, edges connect any two vertices, and a face represents a closed set of edges. Usually each face consists of triangles or quadrilaterals, but any number of sides greater than three is possible. These terms may also refer to an openwork fabric, structure; a net, or network where individual cords, threads, or wires surrounding the spaces cover an input shape. The terms “remote” and “local” generally are not interchangeable and specifically reference to two distinct devices, but may not necessarily describe relative proximity depending on context. For example, items may be stored on a local client datastore and a remote server datastore, but the local datastore may actually be farther away if the local client datastore is actually maintained in cloud storage associated with the client.

Reference is now made in detail to the description of the embodiments as illustrated in the drawings. Particular embodiments described in this application provide specific case implementations of dynamic cellular microstructure construction systems with customization in localized areas of a generated seamless mesh. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

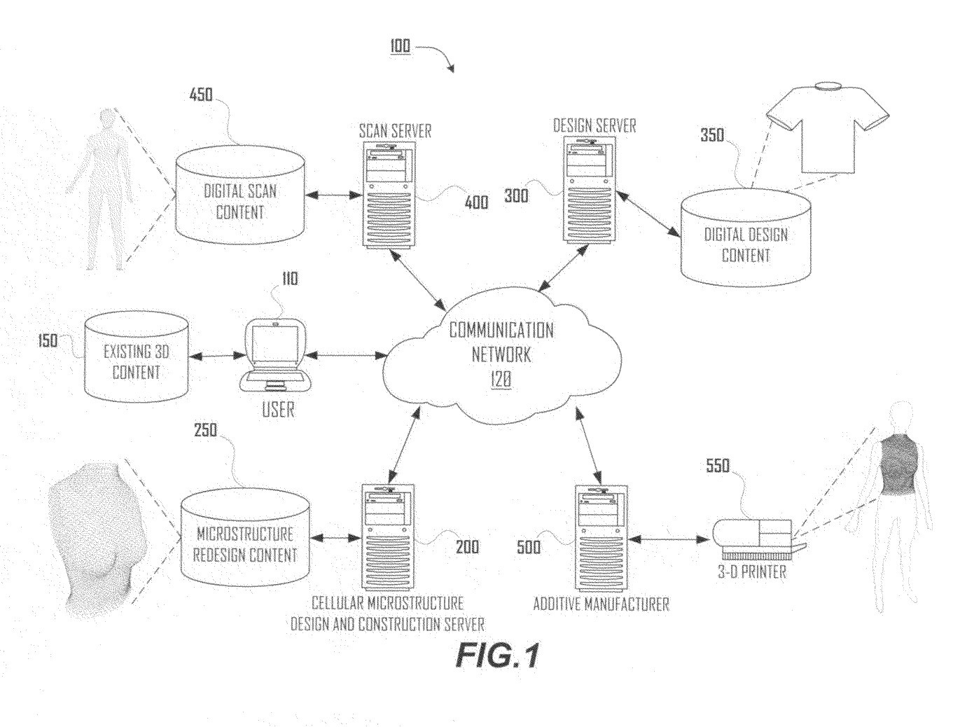

Referring to FIG. 1, a suitable dynamic cellular microstructure design and construction environment 100 is shown wherein designs with attractor points may be applied to available scans with curvature data and retopologized for application to an additive manufacturing construction in accordance with at least one embodiment. In the environment 100, communications network 120 connects a user client device 110 with an existing 3D content datastore 150, a cellular microstructure design and construction server 200 with a microstructure redesign content datastore 250, a design server 300 with a digital design content datastore 350, a scan server 400 with a digital scan content datastore 450, and an additive manufacturer 500 with a 3-D printer 550. In one embodiment, the existing 3D content datastore 150 includes user maintained scans, images, product designs, and content links. In one embodiment, the microstructure redesign content datastore 250 includes cellular microstructures, attractor point modifications, and a content library of materials, designs, styles, and cell/unit microstructures. In one embodiment, the design content datastore 350 includes a content library of materials, designs, styles, and cell/unit microstructures. In one embodiment, the scan content datastore 450 includes scans, images, and a content library of materials, designs, styles, and cell/unit microstructures.

In one embodiment, a user client device 110 may request production of a customized shirt. The user may identify the desired shirt design on the existing local 3D content datastore 150 or on a remote digital design content datastore 350. The cellular microstructure design and construction server 200 receives the desired design and may request an associated user scan to customize construction. The user scan may already be available on the existing local 3D content datastore 150 of the user or on a remote digital scan content datastore 450. Alternatively, in one embodiment, a user may generate a new scan via scan services provided by the scan server 400, which may include use of a 3D scanner, camera, and/or submission of user images or video to the scan server.

The cellular microstructure design and construction server 200 or design server 300 selectively accessing available design projects and optionally joining the digital representation of the 3-D surface with at least one design project, the at least one design server conforming each of the joined design projects to the 3-D surface by identifying a plurality of areas of curvature on the 3-D surface and modifying correlating areas of the joined design projects. In one embodiment, modification may change relative opacity, stretch, drape, compressive strength, plasticity, yield strength, resilience, and Poisson's ratio specific to geometry of a base shape within the design to conform with desired design parameters. Accordingly, localized modification can occur to the materials and/or rules associated with designated base shapes identified within the target area, so that modifications may be made consistent with desired outcome. In one embodiment, the borders of each of the areas of curvature representing a virtual seam within the seamless mesh. Alternatively, the modification effects taper axially from an attractor point.

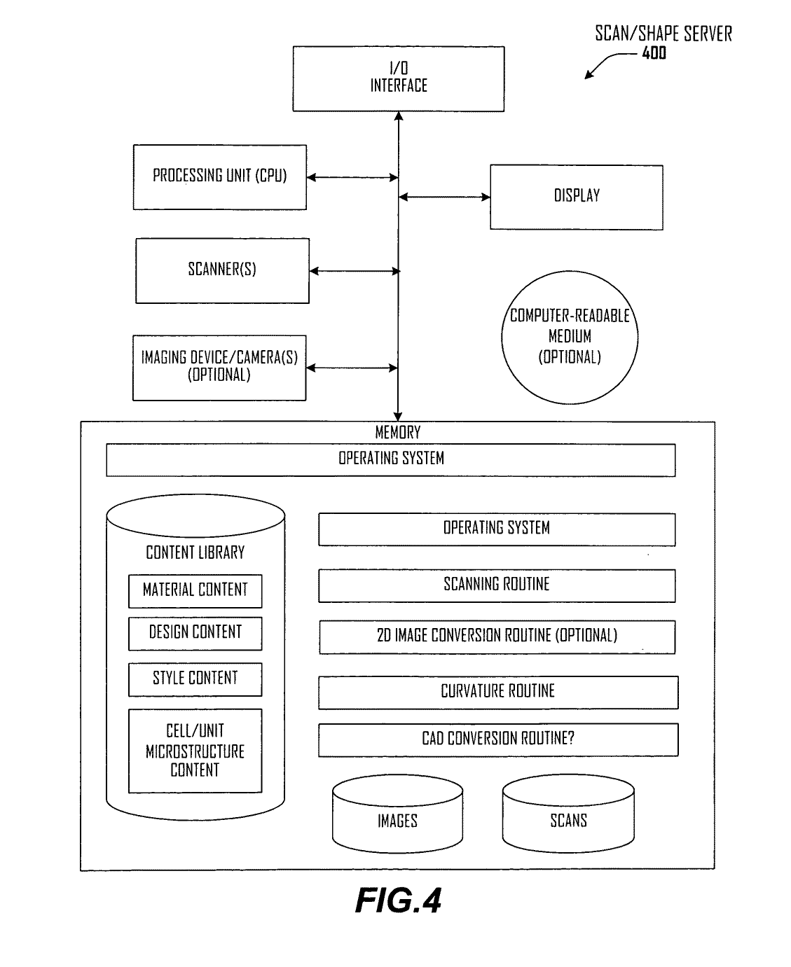

Additional features of the distributed emoji datastore 300 are shown in greater detail in FIG. 4 below. In various embodiments, communication network 120 may include the Internet, a local area network (“LAN”), a wide area network (“WAN”), a wireless data network, a cellular data network, and/or other data network. Moreover, it is understood by those of skill in the art that the communication network 120 may also include any combination of the above.

In some embodiments, other servers and/or devices (not shown) may also be present. Including one or more intermediary application servers and/or platform-provider servers may also be present. For example, in one embodiment, multiple additional client devices and/or non-client devices may be present. Similarly, in one embodiment, multiple design content publishers may also be available to the user to select their desired design. Similarly, a variety of local and remote additive manufacturers may also be present to produce the final product. In various embodiments, the scan server, design server, cellular microstructure design and construction server, additive manufacturer, or some combination of these servers are combined to represent themselves as a single entity to the user. Alternatively, the user may believe selecting a clothing design, scanning the target, customizing the design to the user's target, and printing the customized design are all performed by distributed computing resources controlled by a single entity when each portion is independently maintained.

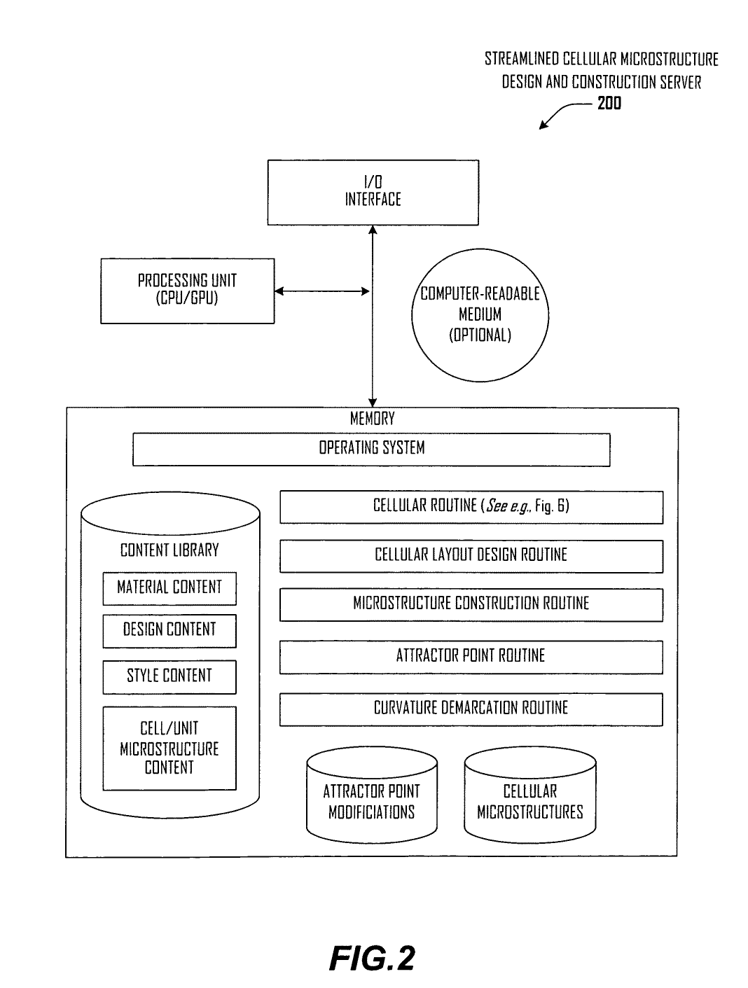

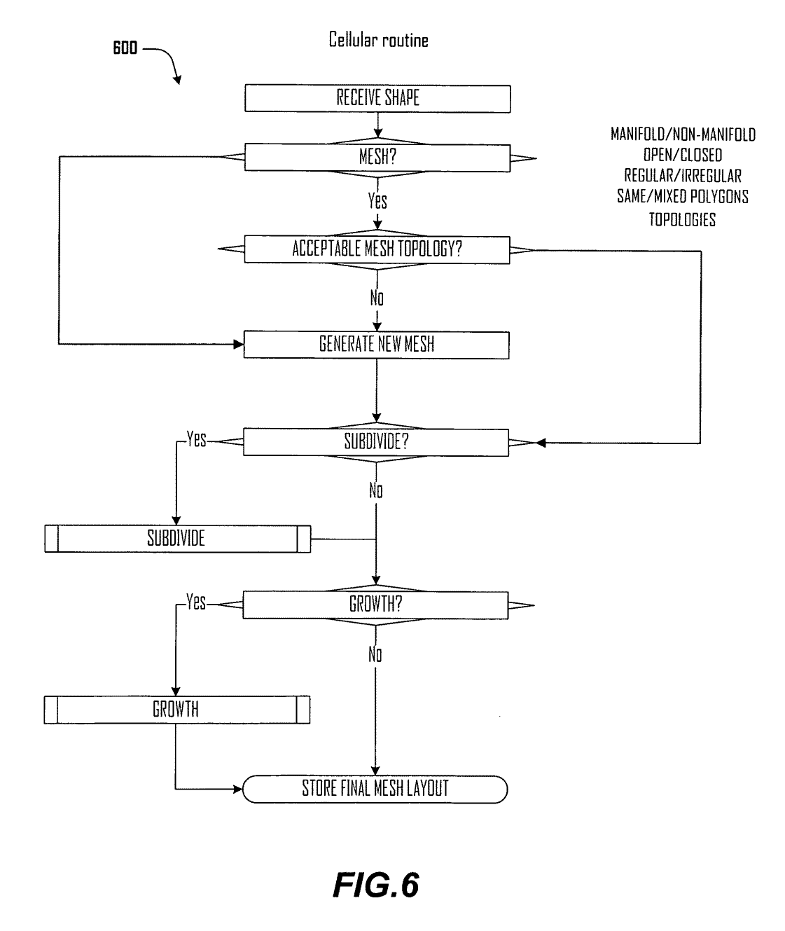

Referring now to FIG. 2 several components of a cellular microstructure design and construction server 200 are shown in accordance with one embodiment. As shown in FIG. 2, the cellular microstructure design and construction server 200 includes a network I/O communication interface 230 for connecting to the communication network 120. The cellular microstructure design and construction server 200 also includes one or more processors collectively represented as a processing unit 210, and memory 250, all interconnected along with the network I/O communication interface 230 via a communication bus 220. The memory 250 generally comprises a random access memory (“RAM”), a read only memory (“ROM”), and a permanent mass storage device, such as a disk drive, flash device, or the like. The memory 250 stores program code for a number of applications, which includes executable instructions for cellular routine 600 (see FIG. 6, discussed below), cellular layout design routine, and microstructure construction routine. As shown in FIG. 2, the memory 250 also includes an attractor point modification datastore, a cellular microstructure datastore, and a content library datastore. In one embodiment, the content library datastore also includes material content, design content, style content, and cell/unit microstructure content. In one embodiment, the content library datastore is distributed within the environment 100. In addition, the memory 250 also stores an operating system 255. These software components may be loaded from a computer readable storage medium 295 into memory 250 of the cellular microstructure design and construction server 200 using a read mechanism (not shown) associated with a non-transient computer readable storage medium 295, such as a floppy disc, tape, DVD/CD-ROM drive, memory card, or the like. In at least one embodiment, software components may also be loaded via the network I/O communication interface 230, rather than via a computer readable storage medium 295.In some embodiments, the cellular microstructure design and construction server 200 may include many more components than those shown in FIG. 2. However, it is not necessary that all of these generally conventional components be shown in order to disclose an illustrative embodiment.

Although a particular cellular microstructure design and construction server 200 has been described that generally conforms to conventional general purpose computing devices, the cellular microstructure design and construction server 200 may be any of a great number of network devices capable of communicating with the communications network 120 and obtaining applications, for example, mainframes, minicomputers, workstations, personal computers, or any other suitable computing device. In some embodiments, some or all of the systems and methods disclosed herein may also be applicable to distributed network devices, such as cloud computing, and the like. Available cloud resources may include applications, processing units, databases, and file services. In this manner, the cellular microstructure design and construction server 200 enables convenient, on-demand network access to a shared pool of configurable design content and related computing services and resources (e.g., networks, servers, storage, applications, and services) that can be rapidly provisioned and released with minimal management effort or service provider interaction. These services may be configured so that any computer connected to the communications network 120 is potentially connected to the group of cellular microstructure design and construction applications, processing units, databases, and files or at the very least is able to submit design requests, customize manufacturing, and/or localized content parameter designations. In this manner, the data maintained by cellular microstructure design and construction server 200 and/or microstructure redesign content datastore 300 may be accessible in a variety of ways by various user client devices 110, for example, a digital tablet, a personal computer, a portable scanner, a handheld computer, a cell phone, or any other device that is capable of accessing the communication network 120.

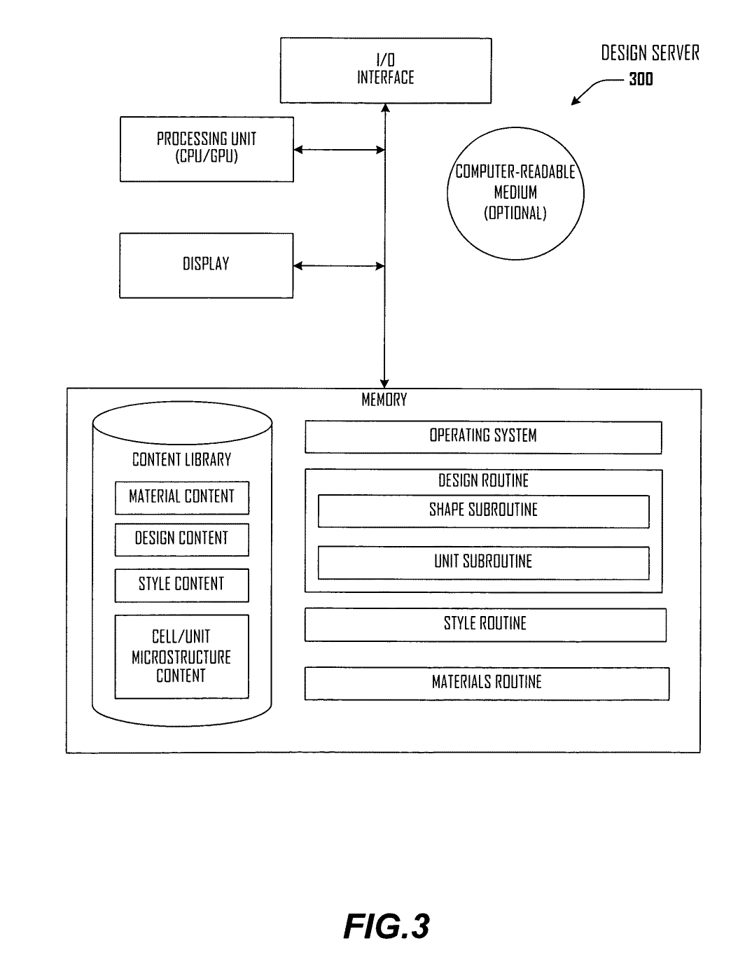

Referring to FIG. 3, several components of a design server 300 are shown in accordance with one embodiment.

Referring to FIG. 4, several components of a scanner server 400 are shown in accordance with one embodiment.

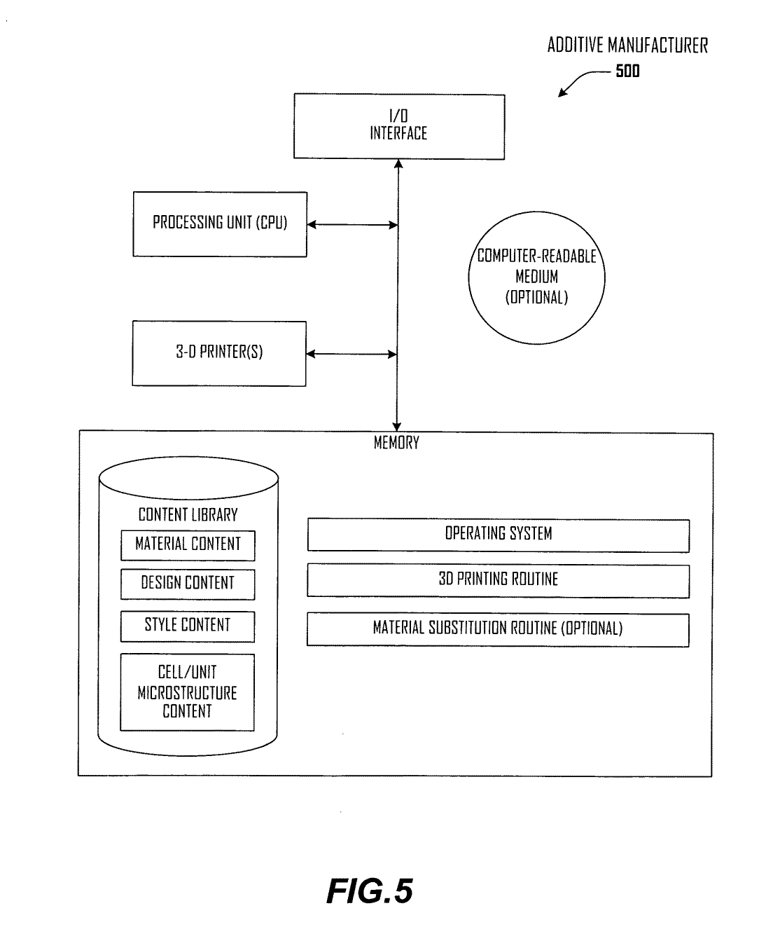

Referring to FIG. 5, several components of an additive manufacturer 500 for 3D printing are shown in accordance with one embodiment.

Referring to FIG. 6, a flow diagram of a cellular microstructure design/seamless mesh production routine 600 for the seamless mesh server are shown in accordance with one embodiment.

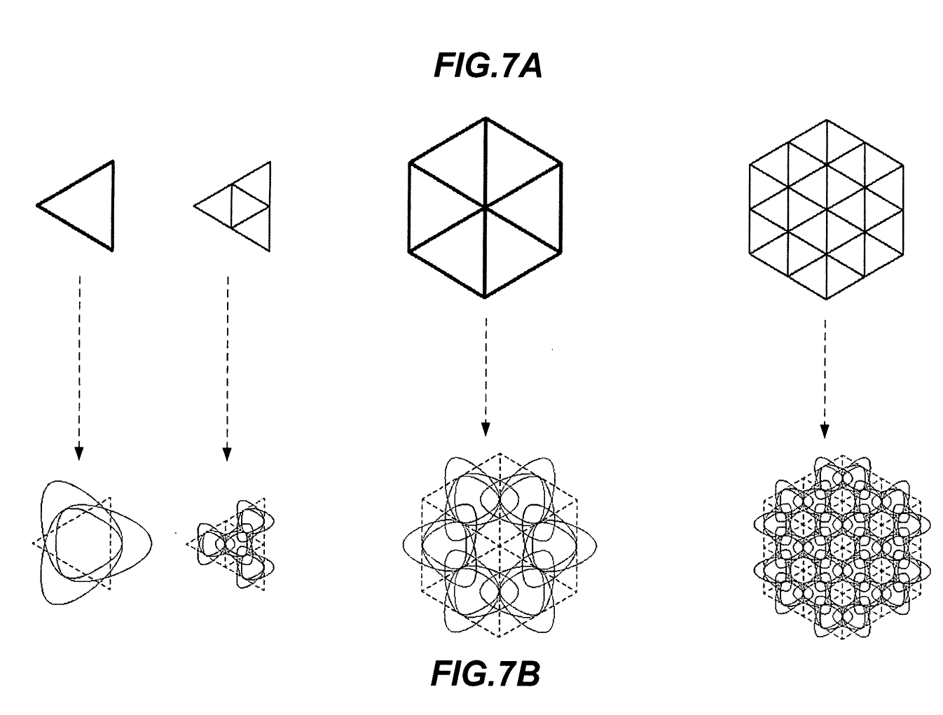

Referring to FIG. 7A, subdivision of a triangular base shape is shown in accordance with one embodiment.

Referring to FIG. 7B, subdivision of a textile cell with a triangular base shape is shown in accordance with one embodiment.

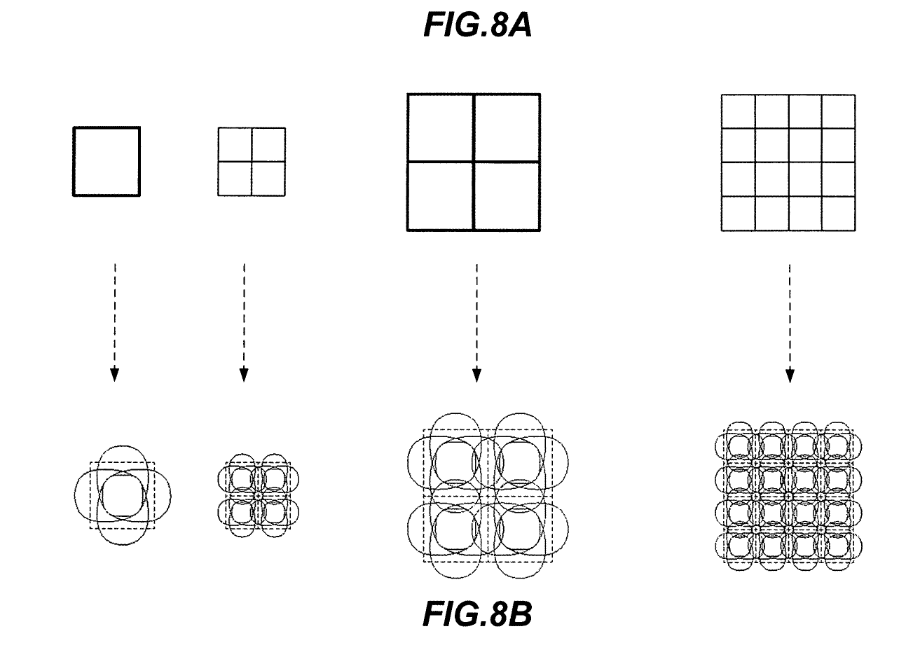

Referring to FIG. 8A, subdivision of a square base shape is shown in accordance with one embodiment.

Referring to FIG. 8B, subdivision of a textile cell with a square base shape is shown in accordance with one embodiment.

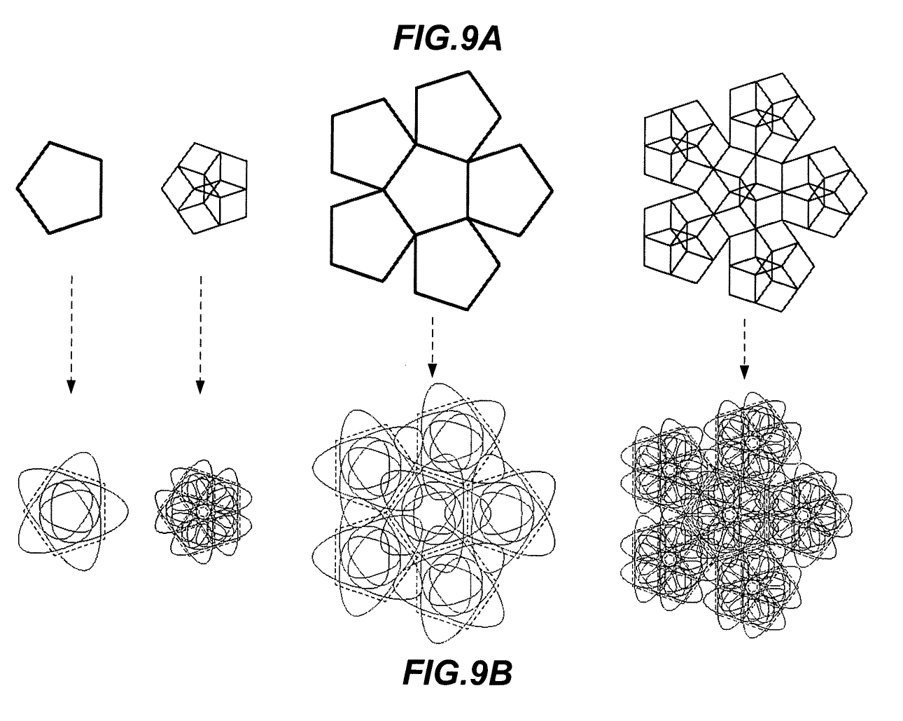

Referring to FIG. 9A, subdivision of a pentagon base shape is shown in accordance with one embodiment.

Referring to FIG. 9B, subdivision of a textile cell with a pentagon base shape is shown in accordance with one embodiment.

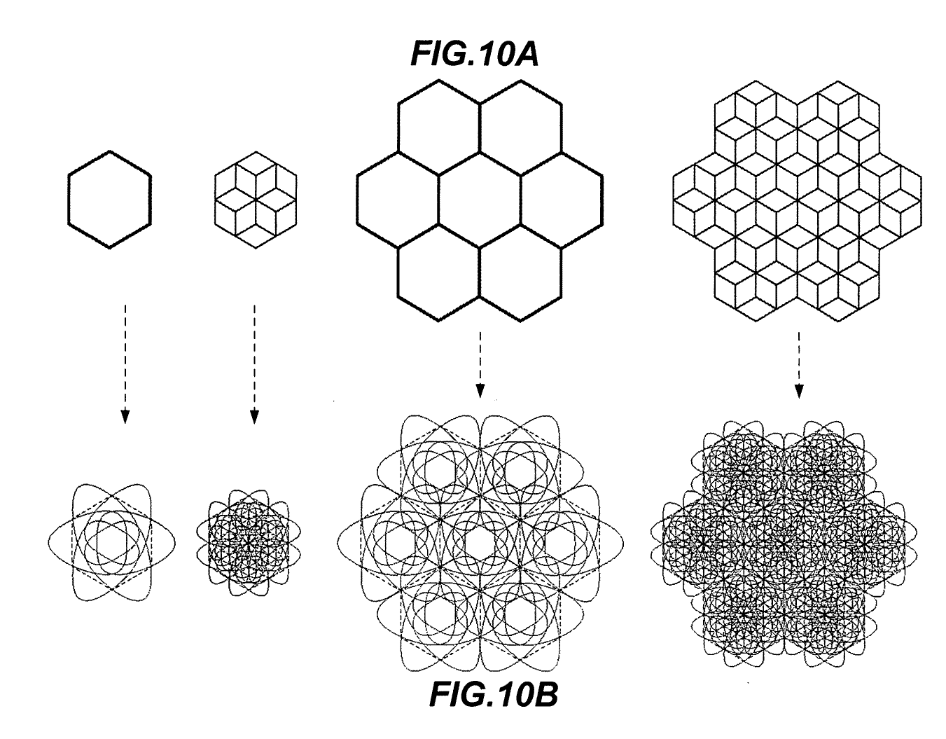

Referring to FIG. 10A, subdivision of a hexagon base shape is shown in accordance with one embodiment.

Referring to FIG. 10B, subdivision of a textile cell with a hexagon base shape is shown in accordance with one embodiment. octagon

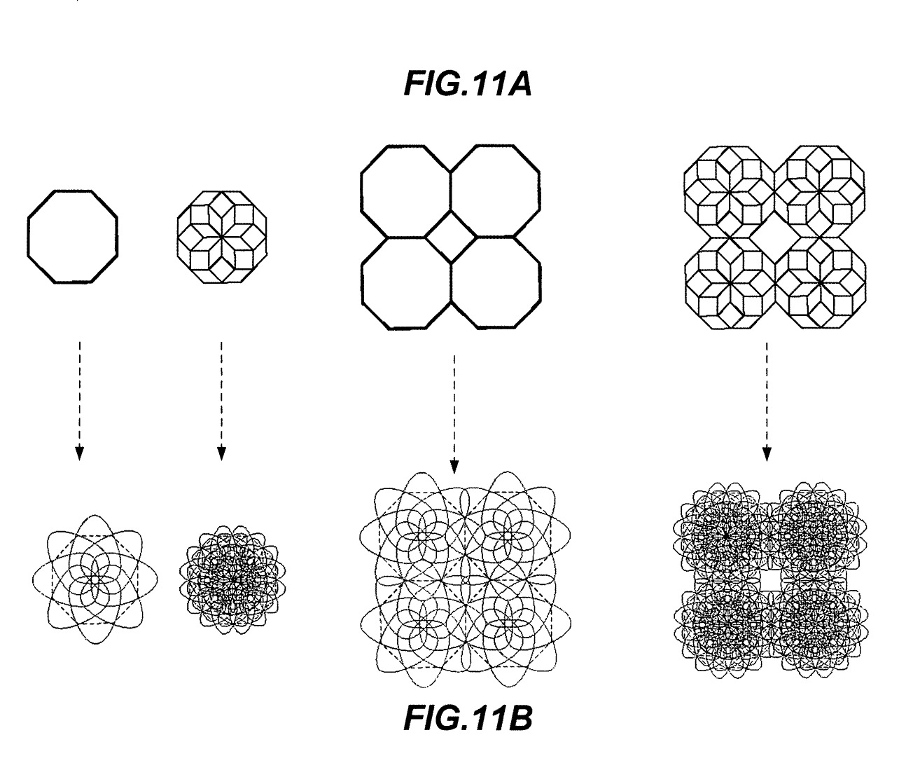

Referring to FIG. 11A, subdivision of an octagon base shape is shown in accordance with one embodiment.

Referring to FIG. 11B, subdivision of a textile cell with an octagon base shape is shown in accordance with one embodiment.

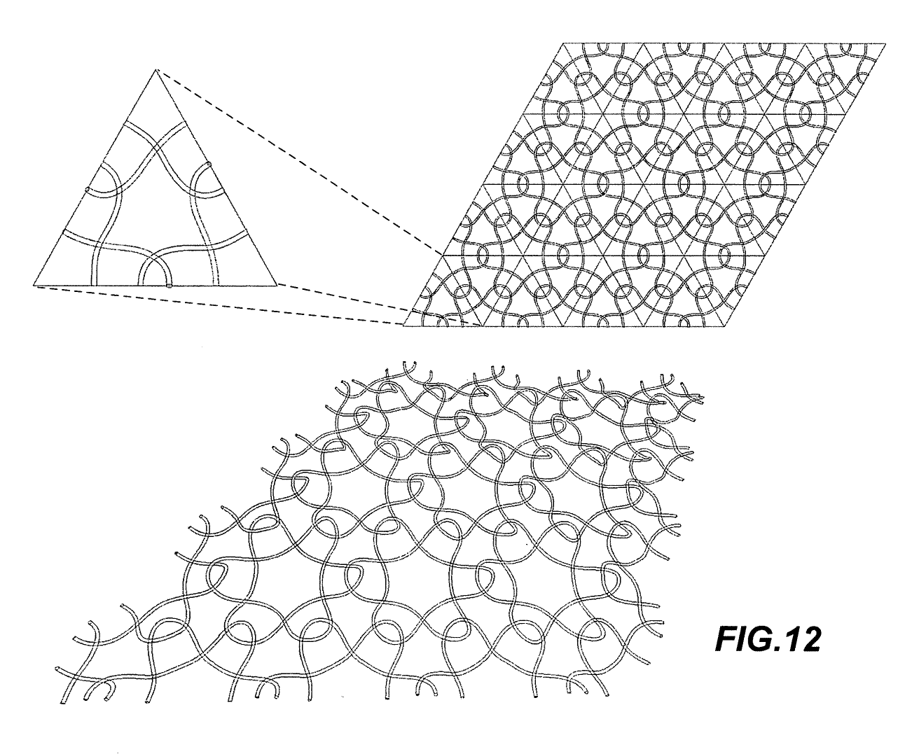

Referring to FIG. 12, an aggregation of textile cells demonstrating an edge interconnection interlocking neighboring textile cells is shown in accordance with one embodiment.

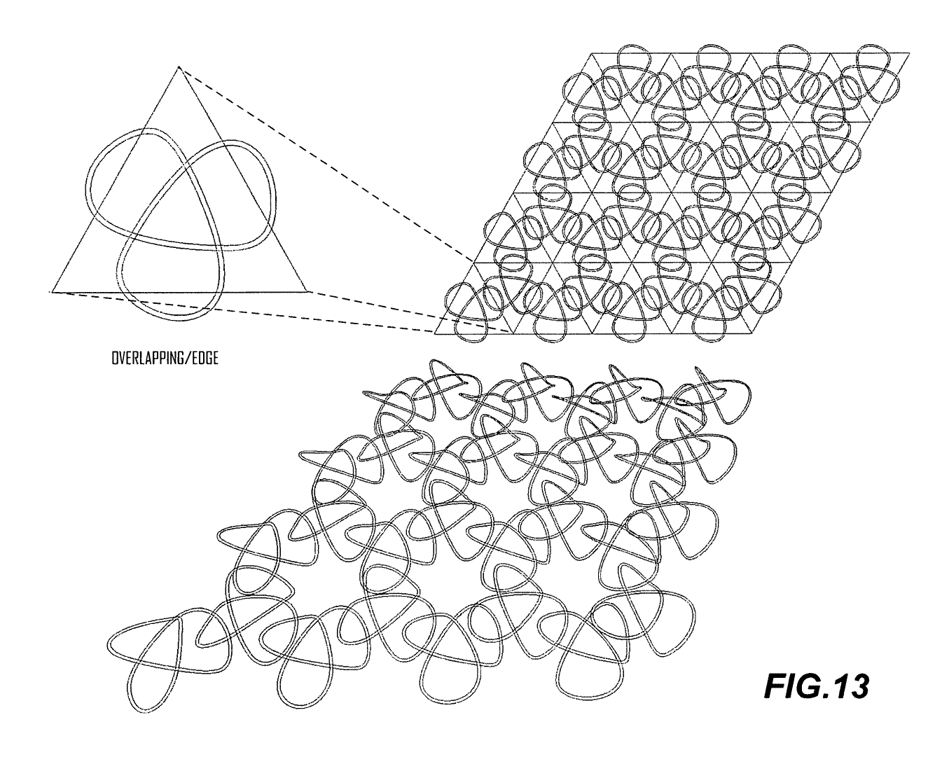

Referring to FIG. 13, an aggregation of textile cells with an overlapping edge interlocking neighboring textile cells is shown in accordance with one embodiment.

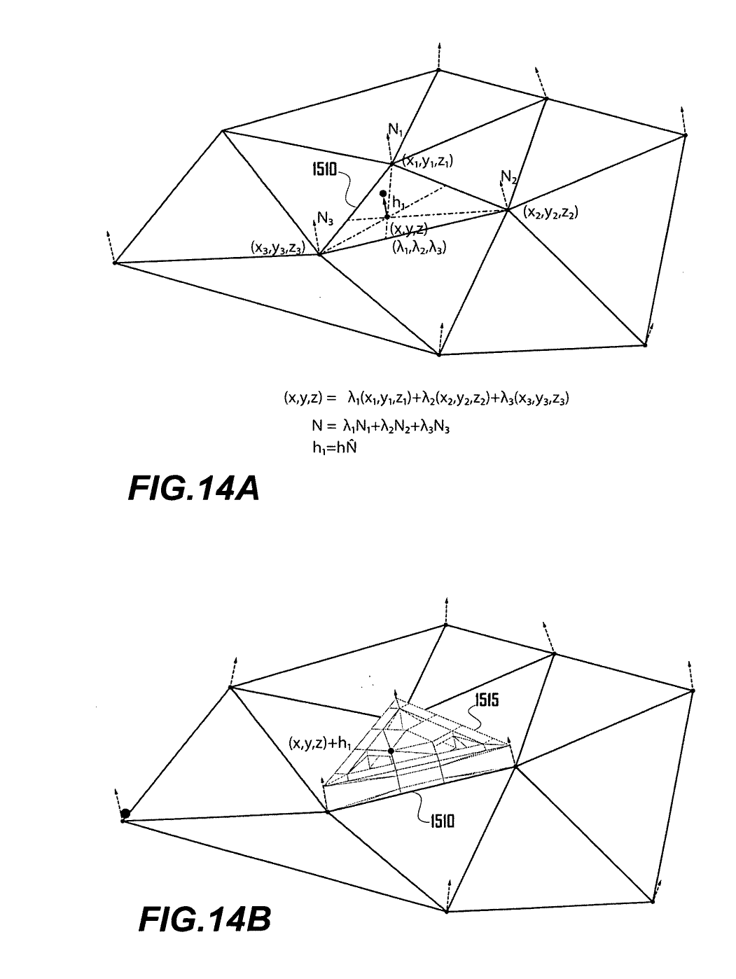

Referring to FIG. 14A, an aggregate surface with several triangular template cells is shown in accordance with one embodiment.

Referring to FIG. 14B, a textile cell mapped to a template cell of a triangular base shape within an aggregate surface is shown in accordance with one embodiment.

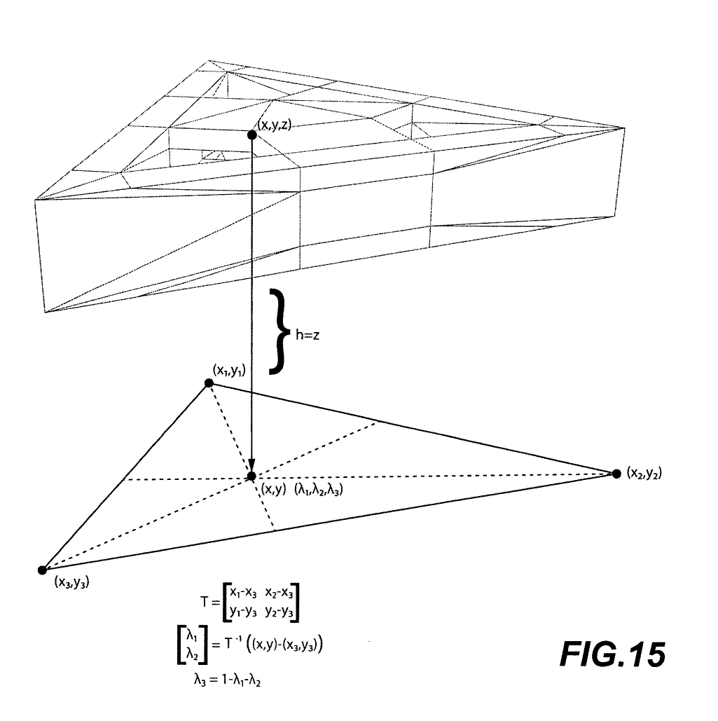

Referring to FIG. 15, mapping a textile cell onto a template cell of a triangular base shape is shown in accordance with one embodiment.

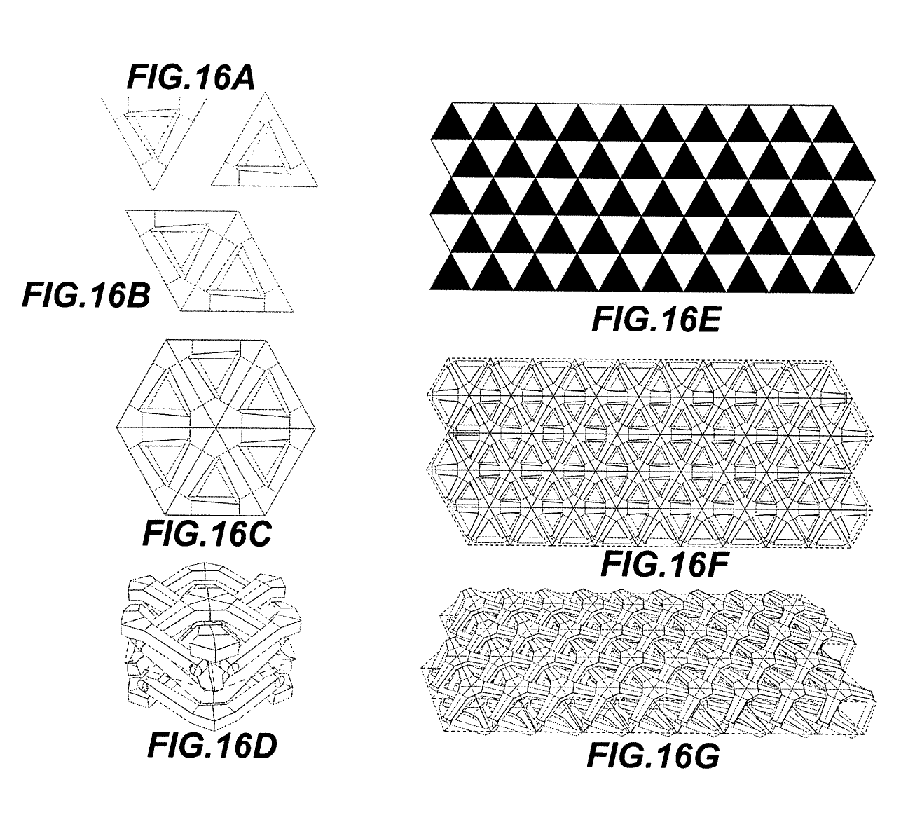

Referring to FIG. 16A, variations of a triangular base shape including a textile cell and an inverted textile cell are shown in accordance with one embodiment.

Referring to FIG. 16B, a textile cell joined to an inverted textile cell is shown in accordance with one embodiment.

Referring to FIG. 16C, a plan view of a hexagon base shape formed from an aggregation of triangular base shapes is illustrated in accordance with one embodiment.

Referring to FIG. 16D, a perspective view of the hexagon base shape shown in FIG. 16C is illustrated in accordance with one embodiment.

Referring to FIG. 16E, a triangular composite mesh using triangle base shapes and inverted triangle base shapes is illustrated in accordance with one embodiment.

Referring to FIG. 16F, a plan view of a hexagon composite mesh formed from the hexagon base shape shown in FIG. 16C is illustrated in accordance with one embodiment.

Referring to FIG. 16G, a perspective view of the hexagon composite seamless mesh shown in FIG. 16F is illustrated in accordance with one embodiment.

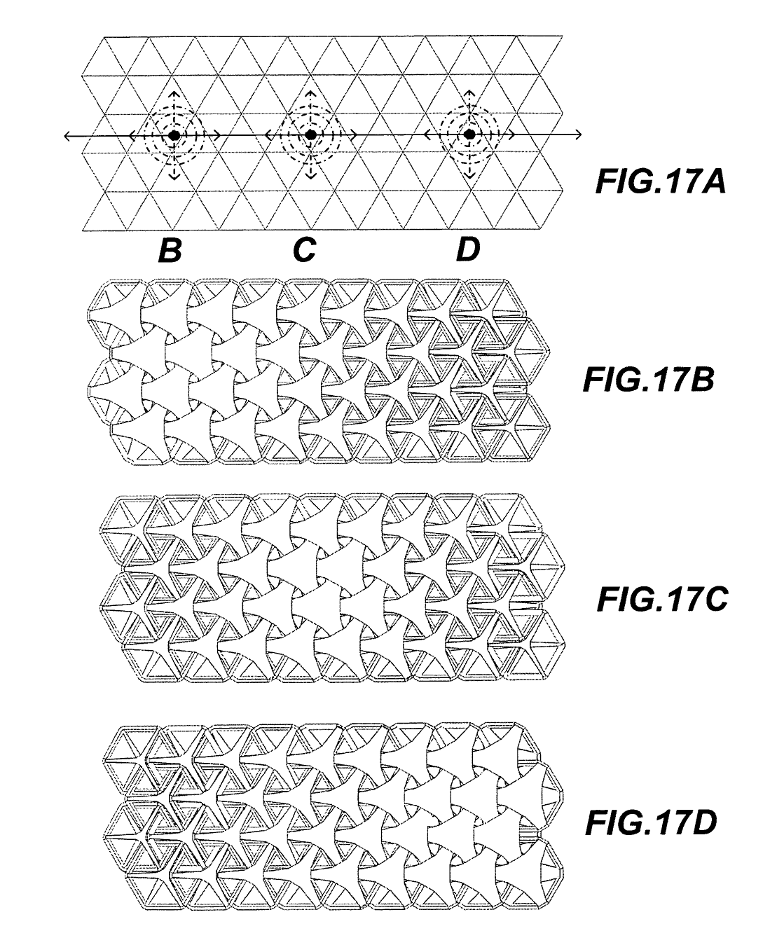

Referring to FIG. 17A, a plan view of a triangular input shape including multiple attractor points (B. C. and D) is illustrated in accordance with one embodiment.

Referring to FIGS. 17B, 17C, and 17D, each illustrate different top views of a seamless mesh thickening different textile cells near each attractor point (B, C, and D respectively) is illustrated in accordance with various embodiments.

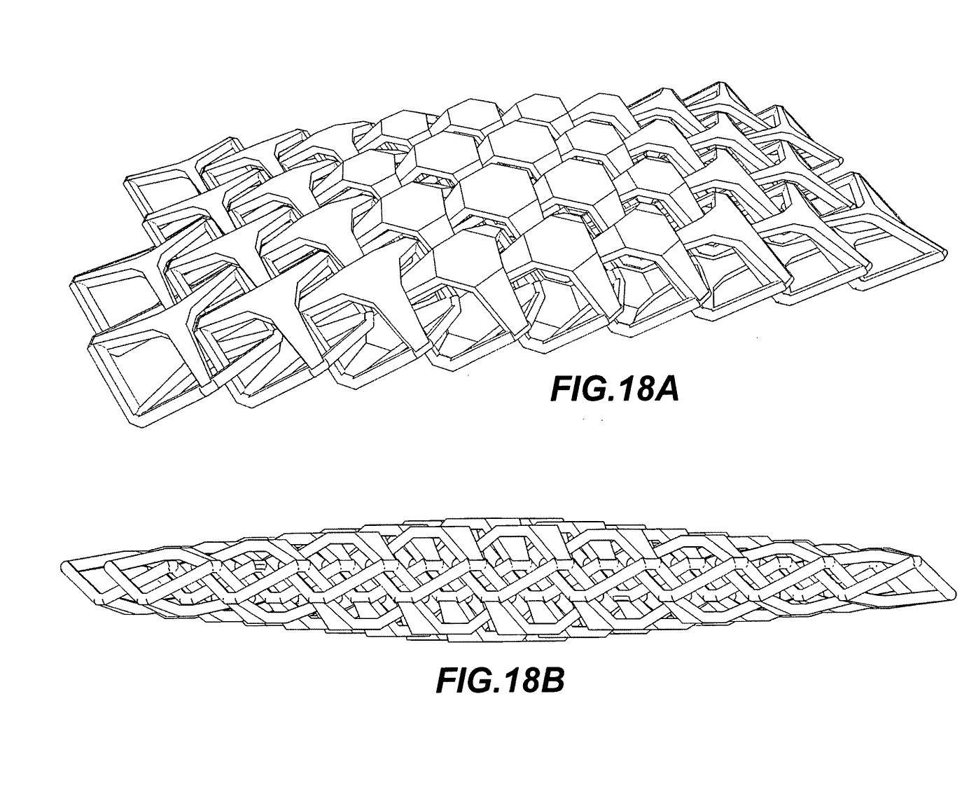

Referring to FIG. 18A, a perspective view of the seamless mesh shown in FIG. 17C is illustrated in accordance with one embodiment.

FIG. 18B illustrates a side view of the seamless mesh shown in FIG. 18A in accordance with one embodiment.

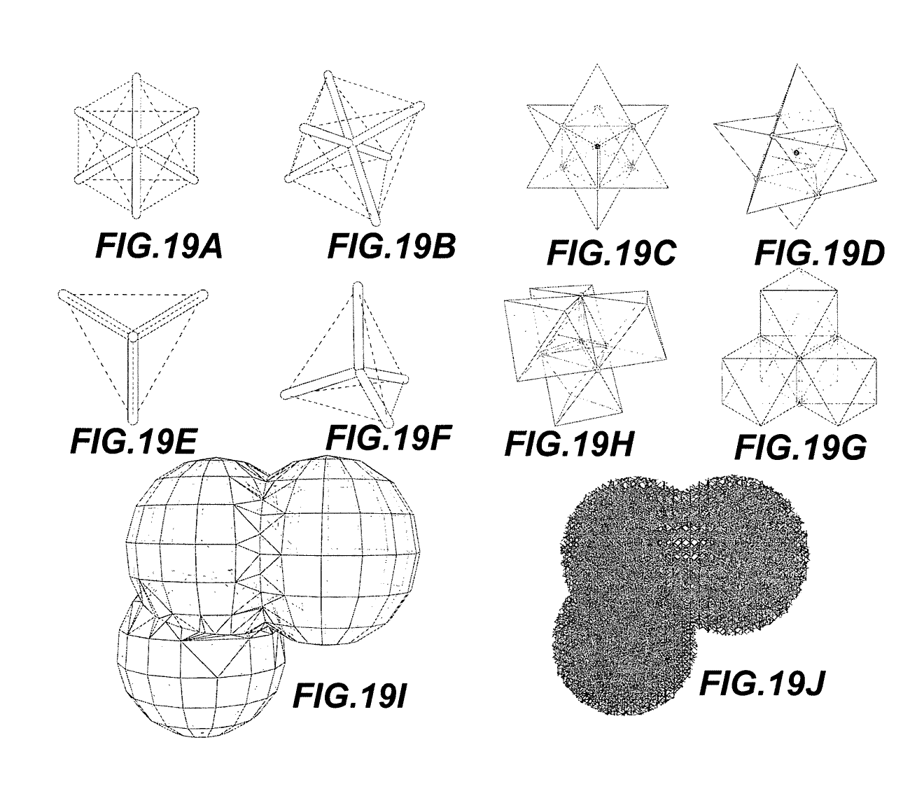

FIG. 19A illustrates a plan view of an octahedral base shape in accordance with one embodiment.

FIG. 19B illustrates a perspective view of the octahedral base shape in FIG. 19A in accordance with one embodiment.

FIG. 19C illustrates a plan view of a volumetric replication of the octahedral base shape shown previously in FIG. 19A and eight tetrahedral base shapes shown previously in FIG. 19E in accordance with one embodiment.

FIG. 19D illustrates a perspective view of a volumetric replication of the octahedral base shape shown previously in FIG. 19A and eight tetrahedral base shapes shown previously in FIG. 19E in accordance with one embodiment.

FIG. 19E illustrates a plan view of a tetrahedral base shape in accordance with one embodiment.

FIG. 19F illustrates a perspective view of the tetrahedral base shape in FIG. 19E in accordance with one embodiment.

FIG. 19G illustrates a plan view of a volumetric replication of the tetrahedral base shape shown in FIG. 19E and four octahedral base shapes shown in FIG. 19A in accordance with one embodiment.

FIG. 19H illustrates a perspective view of a volumetric replication of the tetrahedral base shape shown in FIG. 19E and four octahedral base shapes shown in FIG. 19A in accordance with one embodiment.

FIG. 19I illustrates a perspective view of a volumetric space of an input shape that includes three overlapping spheres in accordance with one embodiment.

FIG. 19J illustrates a perspective view of a seamless mesh of the input shape in FIG. 19I in accordance with one embodiment.

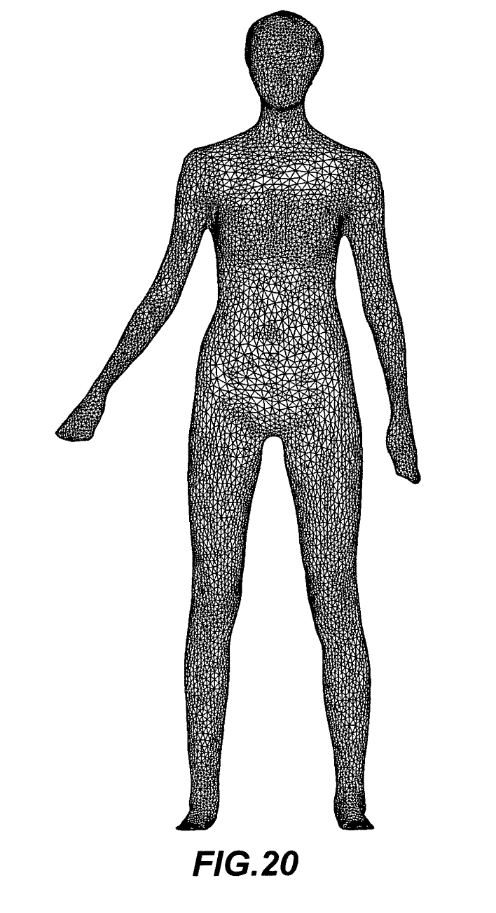

FIG. 20 illustrates a perspective view of a mesh generated from a 3D scan input in accordance with one embodiment.

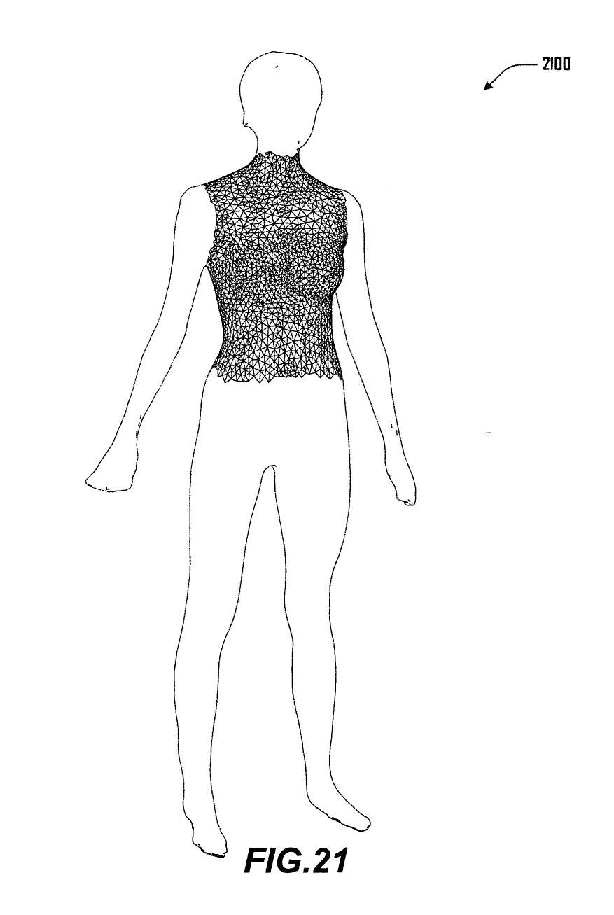

FIG. 21 illustrates a perspective view of an input shape selected from a portion of the 3D scan in FIG. 20 in accordance with one embodiment.

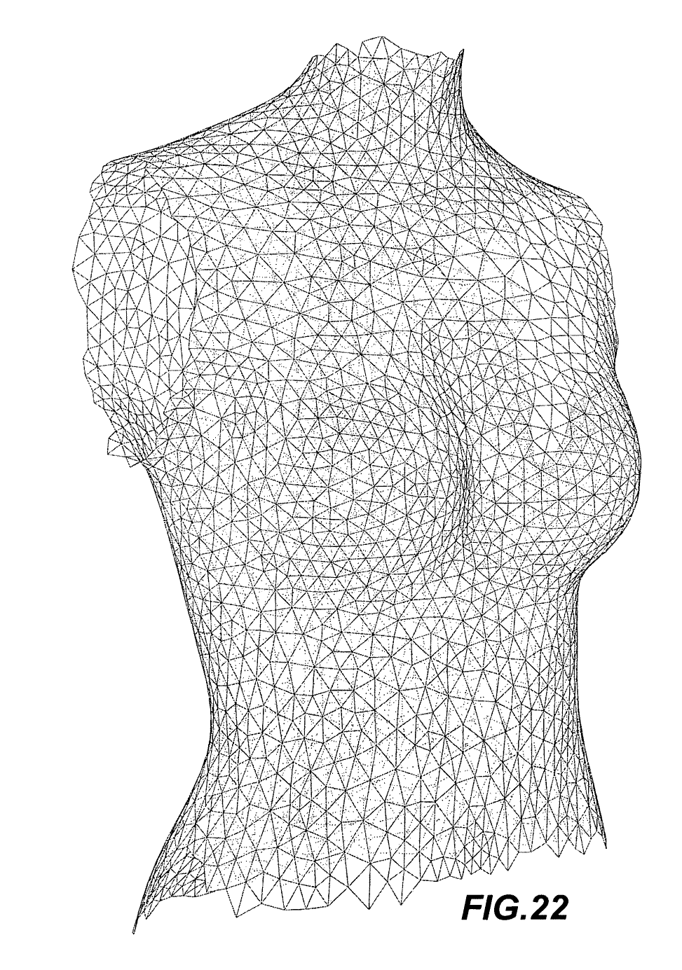

FIG. 22 illustrates a perspective view of an irregular mesh of the input shape in accordance with one embodiment

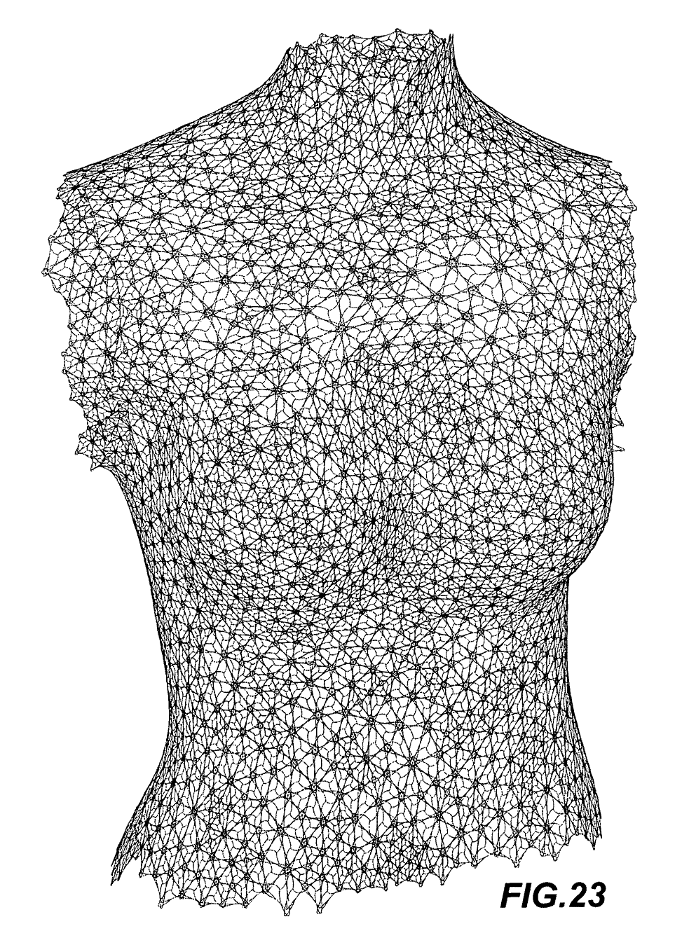

FIG. 23 illustrates a perspective view of the original mesh tessellation replaced with a triangular base shape in accordance with one embodiment.

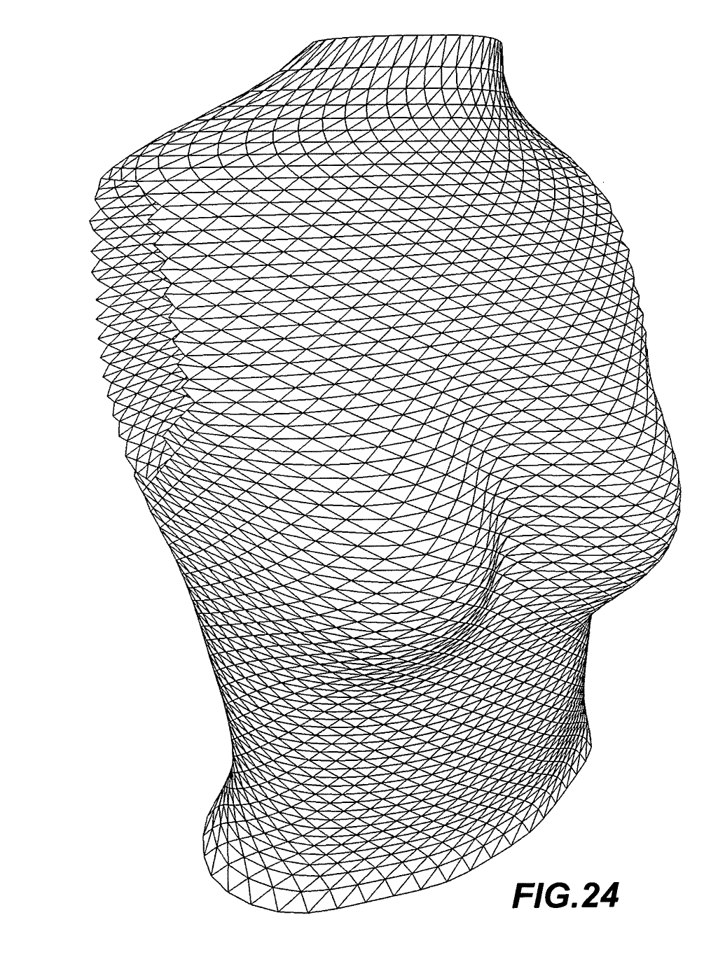

FIG. 24 illustrates a perspective view of a regular mesh of the input shape in accordance with one embodiment.

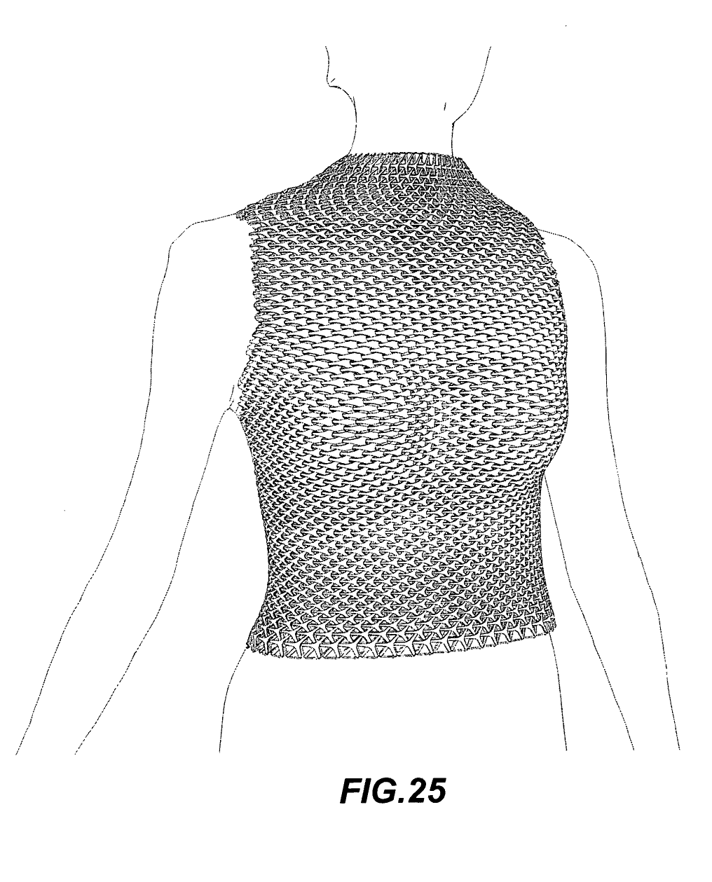

FIG. 25 illustrates a perspective view of the regular mesh with a triangular textile-cell in accordance with one embodiment.

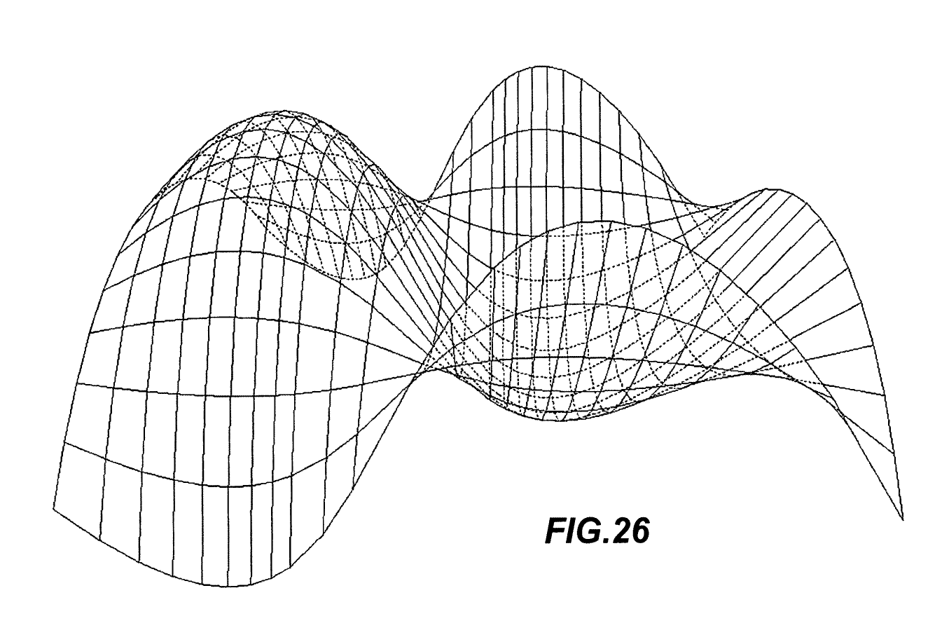

FIG. 26 illustrates an elevation view of an input mesh in accordance with one embodiment.

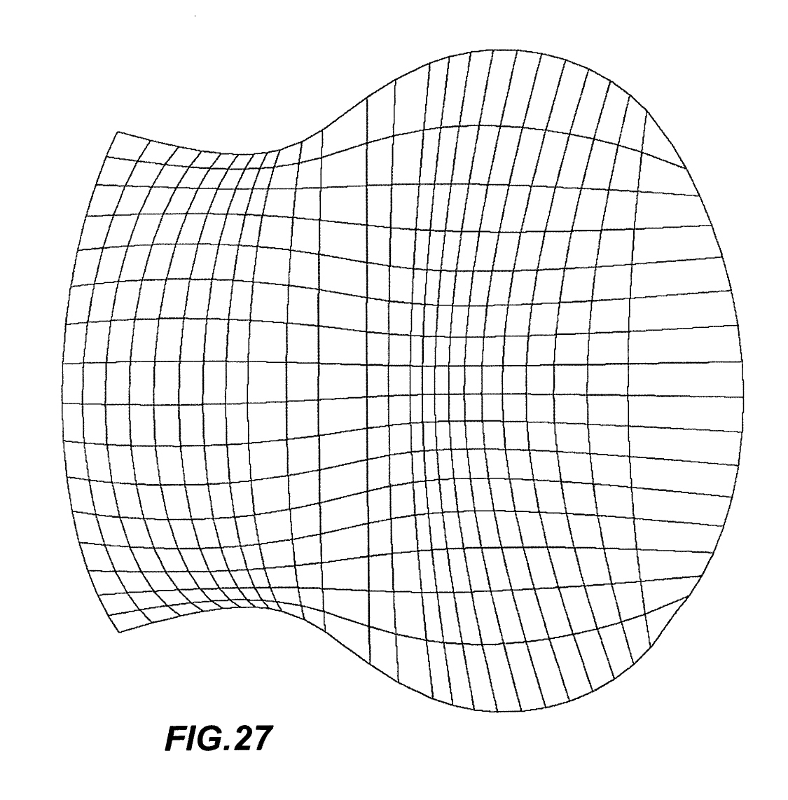

FIG. 27 illustrates a plan view the mesh shown in FIG. 26 in accordance with one embodiment.

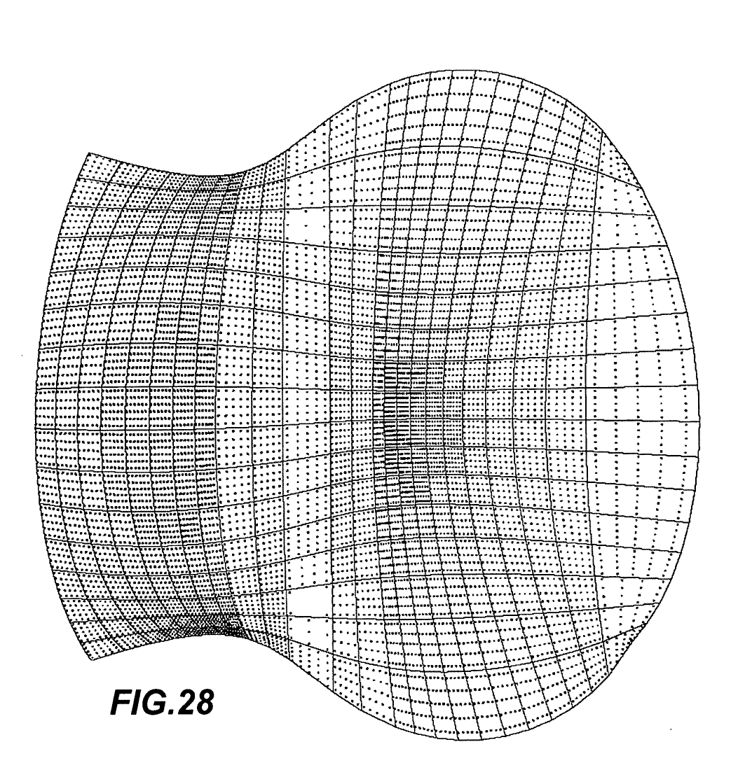

FIG. 28 illustrates a curvature map of the mesh shown in FIG. 26 in accordance with one embodiment.

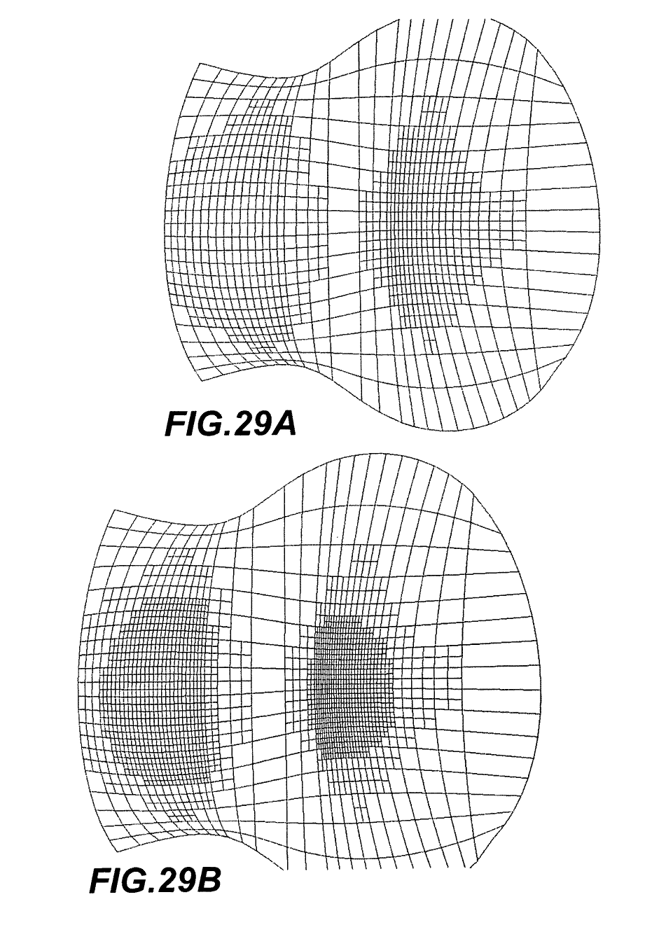

FIG. 29A and FIG. 29 B illustrate top views of new subdivided input meshes in accordance with one embodiment.

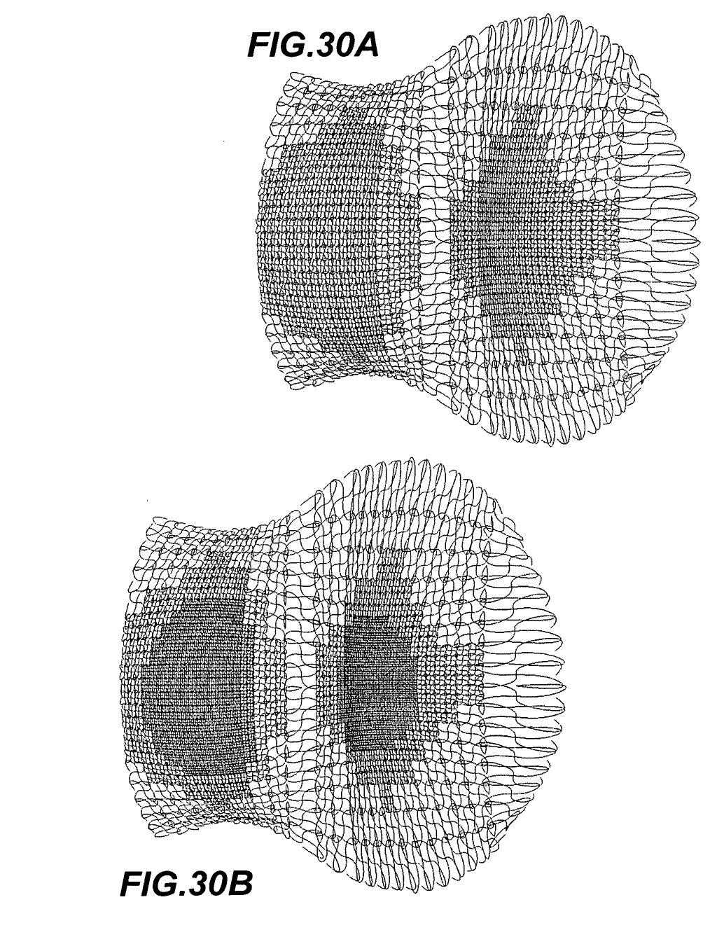

FIG. 30A and FIG. 30B illustrates top views of textile cells being applied to the new subdivided input meshes shown in FIG. 29A and FIG. 29B in accordance with one embodiment.

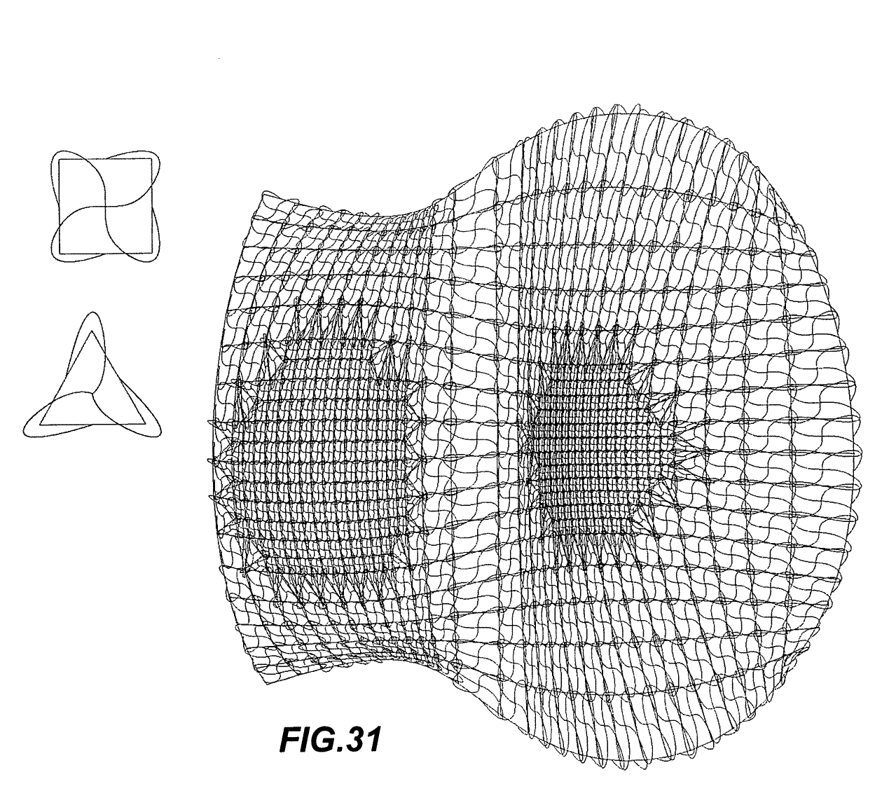

FIG. 31 illustrates a top view the mesh using multiple base shapes in accordance with one embodiment.

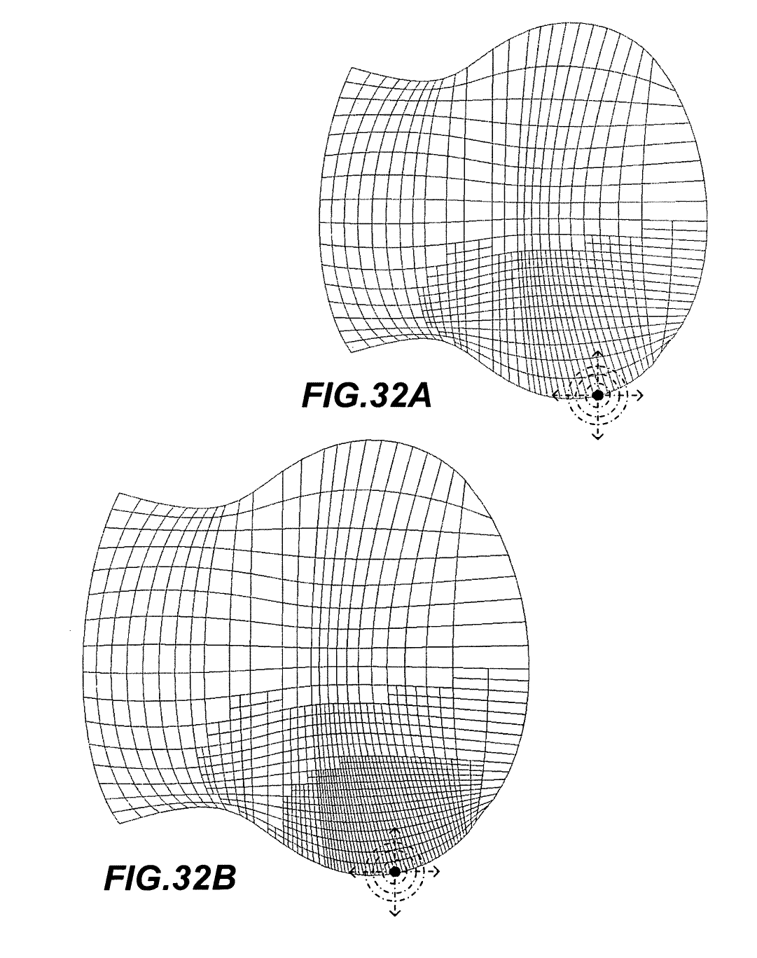

FIG. 32A and FIG. 32B illustrate top views of the input mesh with attractor points in accordance with one embodiment.

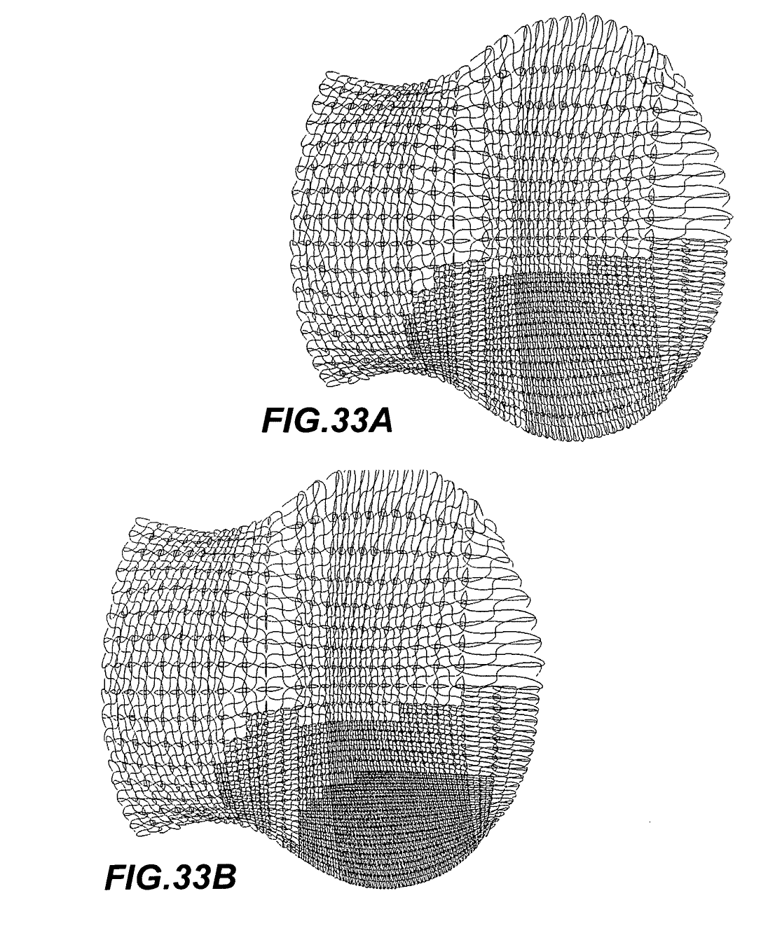

FIG. 33A and FIG. 33B illustrate top views of textile cells applied to the input mesh with attractor points in accordance with one embodiment.

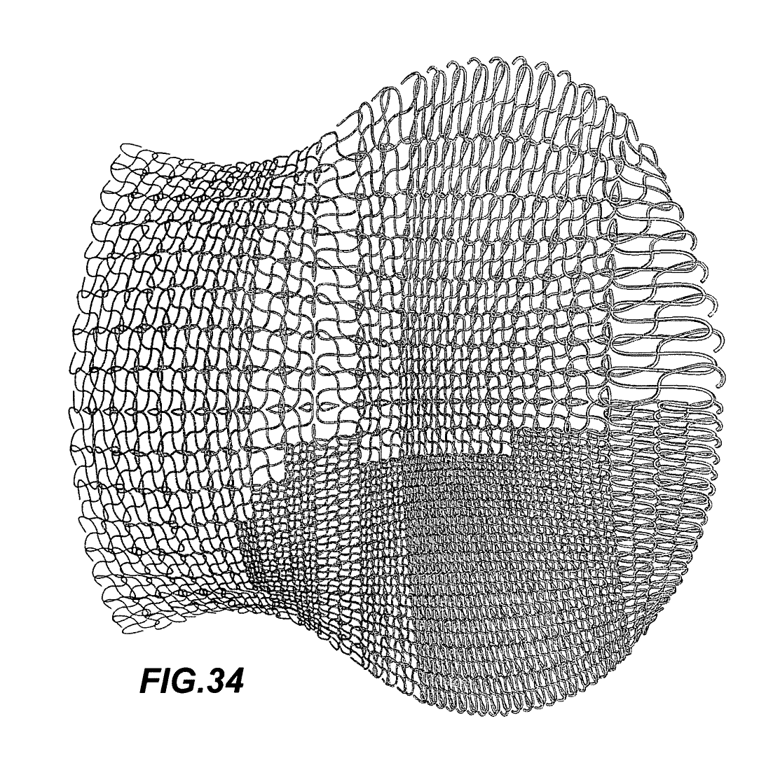

FIG. 34 illustrates a top view of a seamless mesh with curvature variation in accordance with one embodiment.

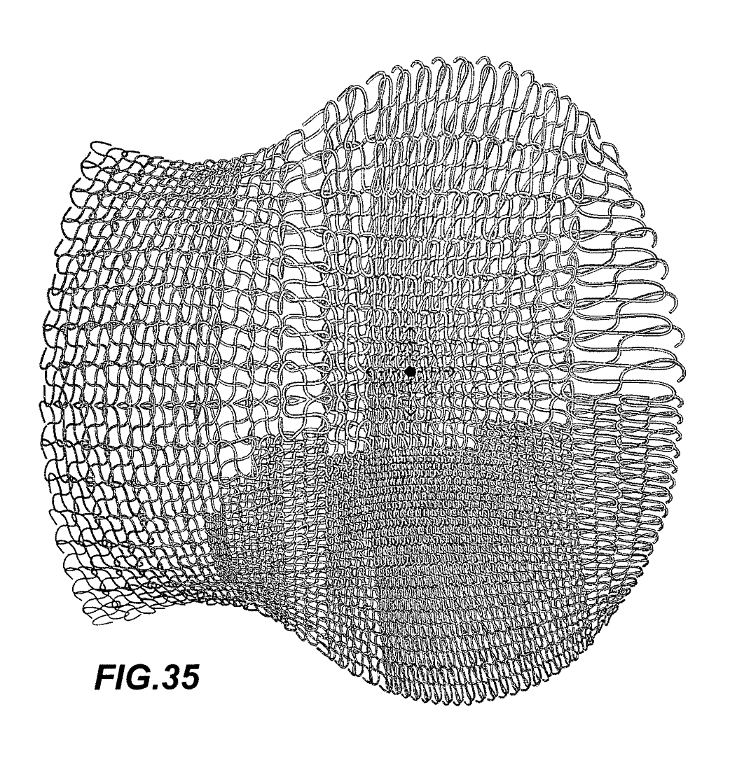

FIG. 35 illustrates a top view the seamless mesh with attractor point and curvature variation in accordance with one embodiment.

Although specific embodiments have been illustrated and described herein, a whole variety of alternate and/or equivalent implementations may be substituted for the specific embodiments shown and described without departing from the scope of the present disclosure. This application is intended to cover any adaptations or variations of the embodiments discussed herein.

1. A method of manufacturing a seamless mesh, comprising:
obtaining at least one 3-D scan of a 3-D surface and/or a surface design to be at least partially covered by the seamless mesh;
demarcating a portion of the obtained 3-D scan and/or surface design as an input shape for the seamless mesh;
identifying at least one base shape for use in creating the seamless mesh on the input shape;
replicating the at least one base shape to cover the input shape with replicated base shapes that form the seamless mesh; and
modifying the at least one base shape in localized areas of the seamless mesh based on relative proximity curvature of the input shape.

2. The method as recited in claim 1, wherein the modifying the base shape includes changing at least one of opacity, thickness, stretch, drape, and size of the base shape.

3. The method as recited in claim 1, wherein the base shape is a space filling polyhedral.

4. The method as recited in claim 1, wherein the input shape is generated using the 3-D scan.

5. The method as recited in claim 1, wherein the replicating the base shape includes identifying at least one vertex of an original base shape, generating at least one additional base shape and rotating placement of the generated at least one additional base shape about the at least one vertex of the original base shape, upon placement of the at least one additional base shape about the original base shape continuing replication of the base shape using the at least one additional base shape as the new original base shape until the at least one additional base shape covers the input shape.

6. The method as recited in claim 1, wherein the at least one base shape is interlocked with at least one additional replicated base shape.

7. The method as recited in claim 1, wherein the at least one base shape and at least one additional replicated base shape are interconnected along at least one edge of the base shape.

8. The method as recited in claim 1, wherein the at least one base shape partially overlaps with at least one neighboring base shape.

9. The method as recited in claim 1, further comprising modifying the input shape to cover a portion of the 3-D surface based on the 3-D scan with the mesh based in part on the surface design, wherein any correspondence between the surface design and the at least one 3-D scan of the 3-D surface scan merely reflects the desire to use the surface design on the scanned surface.

10. The method as recited in claim 1, wherein the surface design includes identification of relative design parameters desirable for the seamless mesh, the design parameters including opacity, thickness, stretch, drape, and size.

11. The method as recited in claim 1, wherein the surface design and/or the mesh is an article of clothing.

12. The method as recited in claim 1, further comprising printing the seamless mesh using additive manufacturing techniques.

13. The method as recited in claim 1, wherein the identifying the at least one base shape for the mesh, includes identifying different base shapes based on the input shape.

14. A computer program product residing on a non-transient computer readable storage medium having a plurality of instructions stored thereon which, when executed by a processor, cause the processor to perform operations comprising:
demarcating, using surface-based coordinates, a plurality of areas of curvature on a digital representation of an input shape, each area of curvature representing a portion of a seamless mesh designed to cover at least a portion of the input shape; and
modifying at least one base shape within each area of curvature of the mesh to accommodate the curvature relative to other portions of the seamless mesh.

15. The method as recited in claim 14, further comprising predicting how a change to the at least one base shape will affect mesh properties in a designated area of curvature.

16. The method as recited in claim 14, wherein the borders of each of the areas of curvature represent a virtual seam within the seamless mesh and the modifying includes modifying at least one base shape along each virtual seam to interlock/interconnect at least one neighboring base shape of a neighboring area of curvature of the seamless mesh.

17. The method as recited in claim 14, wherein the seamless mesh is a design for an article of clothing.

18. The method as recited in claim 14, wherein the modifying includes changing opacity, thickness, stretch, drape, and size of the base shape used for the mesh in a designated area of curvature.

19. An product design system comprising:
at least one 3-D imaging device to generate a digital representation of a 3-D surface based on a surface scan received from at least one remote scanning device; and
at least one design server in communication with the at least one 3-D imaging device, the at least one design server selectively accessing available design projects and optionally joining the digital representation of the 3-D surface with at least one design project, the at least one design server conforming each of the joined design projects to the 3-D surface by identifying a plurality of areas of curvature on the 3-D surface and modifying correlating areas of the joined design projects.

20. The system recited in claim 19, wherein the modifying includes changing opacity, thickness, stretch, drape, and size of at least one base shape used for the design project.
